(19) United States
(12) Patent Application Publication
(10) Pub. No.: US 2009/0325680 A1
(43) Pub. Date: Dec. 31, 2009

(54) Game System

(75) Inventor: Shinji TSUKABE, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/492,269

(22) Filed: Jun. 26, 2009

Related U.S. Application Data
(60) Provisional application No. 61/076,332, filed on Jun. 27, 2008.
(60) Provisional application No. 61/076,302, filed on Jun. 27, 2008.

(51) Int. Cl. A63F 9/24; A63F 13/00

(52) U.S. Cl. 463/20; 463/30; 463/42

(57) ABSTRACT

A new gaming environment is provided. A server determines a first predetermined time and a second predetermined time, determines display content based on the second predetermined time which is determined, displays the determined display content on the display, determines a gaming machine to which a bonus is provided from the plural gaming machines when current time becomes the second predetermined time, and sends winning information to the determined gaming machine, and the gaming machine sends the determined information to the server each time there is start operation of a game, and payouts a predetermined number of gaming medium when the winning information is received.

### CROSS-REFERENCE TO RELATED APPLICATIONS

This application is based upon and claims priority from the U.S. Provisional Patent Application No. 61/076,332 filed on Jun. 27, 2008, and the U.S. Provisional Patent Application No. 61/076,302 filed on Jun. 27, 2008, the entire contents thereof are incorporated herein by reference for all purposes.

### BACKGROUND

1. Field

One or more aspects of the present invention relate to a game system, a server, a gaming machine in which a gaming machine to which a bonus will be provided is determined at a predetermined time and further relate to a game system and a server in which a gaming machine to which a bonus will be provided is determined when the number of executed games on plural gaming machines reaches a predetermined number.

2. Description of Related Art

There are slot machines in which bonus occurs in a predetermined condition to enhance an entertainment aspects. Also, a probability of occurrence of the bonus is controlled based on the bet number in some of the conventional slot machines. Also, to attract players, a game system, and a server, and a gaming machine which has new feature is anticipated.

### SUMMARY

In view of the foregoing, one or more aspects of the invention relate to a game system, a server, a gaming machine, a gaming method thereof, a computer readable medium having computer-executable instructions or the like in which a new gaming environment is provided.

A game system according to one or more aspects of the invention comprises gaming machines, a server connected to the gaming machines, and a display. The server determines a second predetermined time at a first predetermined time, determines display content based the determined second predetermined time, displays the determined display content on the display, determines a specific gaming machine of the gaming machines, the specific gaming machine realizing a bonus, and sends winning information to the determined specific gaming machine. Each of the gaming machines sends predetermined information to the server when a start operation of a game is accepted and provides a predetermined number of gaming medium when the winning information is received.

Herewith, since a bonus is provided to any of the gaming machines connected to a server at a predetermined time, an entertainment aspect of the game system may be enhanced, and it may attract more players.

A server according to one or more aspects of the invention is connected to the gaming machines. The server determines a second predetermined time at a first predetermined time, determines display content based the determined second predetermined time, displays the determined display content on the display, determines a specific gaming machine of the gaming machines, the specific gaming machine realizing a bonus, and sends winning information to the determined specific gaming machine.

Herewith, since a bonus is provided to any of the gaming machines connected to a server at a predetermined time, an entertainment aspect of the game system may be enhanced, and it may attract more players.

A gaming machine according to one or more aspects of the invention is connected to a server. The gaming machine sends predetermined information to the server when a start operation of a game is accepted and provides a predetermined number of gaming medium when the winning information is received.

Herewith, since a bonus is provided to any of the gaming machines connected to a server at a predetermined time, an entertainment aspect of the game system may be enhanced, and it may attract more players.

A game system according to one or more aspects of the invention comprises gaming machines, a server connected to the gaming machines, and a display. The server determines a second predetermined time at a first predetermined time, determines display content based the determined second predetermined time, displays the determined display content on the display, determines a specific gaming machine of the gaming machines when a current time becomes the second predetermined time, the specific gaming machine realizing a bonus, and sends winning information to the determined specific gaming machine. Each of the gaming machines sends predetermined information to the server when a start operation of a game is accepted, and provides a predetermined number of gaming medium when the winning information is received.

Herewith, since a bonus is provided to any of the gaming machines connected to a server when the number of executed games on plural gaming machines reaches a predetermined number, an entertainment aspect of the game system may be enhanced, and it may attract more players.

A server according to one or more aspects of the invention is connected to the gaming machines. The server determines a second predetermined time at a first predetermined time, determines display content based the determined second predetermined time, displays the determined display content on the display, determines a specific gaming machine of the gaming machines, the specific gaming machine realizing a bonus, and sends winning information to the determined specific gaming machine.

Herewith, since a bonus is provided to any of the gaming machines connected to a server when the number of executed games on plural gaming machines reaches a predetermined number, an entertainment aspect of the game system may be enhanced, and it may attract more players.

One or more of the above aspects of the invention is more fully described in the following detailed description when read in connection with the accompanying drawings. It is to be expressly understood, however, that the drawings are for purpose of illustration only and not intended as a definition of the limits of the disclosure.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

FIG. 1 is a flowchart of a server base process in accordance with one or more aspects of the invention.

FIG. 2 is a schematic structure view of a game system in accordance with one or more aspects of the invention.

FIG. 3 is an external perspective view of the game system in accordance with one or more aspects of the invention.

FIG. 4 is an external perspective view of a slot machine in accordance with one or more aspects of the invention.

FIG. 5 is a block diagram showing an internal constitution of the game system in accordance with one or more aspects of the invention.

FIG. 6 is a block diagram showing an internal constitution of the slot machine in accordance with one or more aspects of the invention.

FIG. 7 is a block diagram showing the internal constitution of the slot machine in accordance with one or more aspects of the invention.

FIG. 8 is a flowchart of a main control process in accordance with one or more aspects of the invention.

FIG. 9 is a flowchart of a main game process in accordance with one or more aspects of the invention.

FIG. 10 is an explanatory view of a lottery table in a mystery bonus in accordance with one or more aspects of the invention.

FIG. 11 is an explanatory view of display content on a large display in accordance with one or more aspects of the invention.

FIG. 12 is a flowchart of the server base process in accordance with one or more aspects of the invention.

FIG. 13 is an explanatory view of a table for number of games in accordance with one or more aspects of the invention.

FIG. 14 is a flowchart of the server lottery process in accordance with one or more aspects of the invention.

FIG. 15 is a flowchart of a first winning information sending process in accordance with one or more aspects of the invention.

FIG. 16 is an explanatory view of the table for number of games in accordance with one or more aspects of the invention.

FIG. 17 is a flowchart of a main game process of the game system in accordance with one or more aspects of the invention.

FIG. 18 is a flowchart of the server base process in accordance with one or more aspects of the invention.

FIG. 19 is an explanatory view of a table of a difference value in accordance with one or more aspects of the invention.

FIG. 20 is a flowchart of the server base process in accordance with one or more aspects of the invention.

FIG. 21 is a flowchart of a second winning information sending process in accordance with one or more aspects of the invention.

FIG. 22 is a flowchart of a server base process in accordance with one or more aspects of the invention.

FIG. 23 is a schematic structure view of a game system in accordance with one or more aspects of the invention.

FIG. 24 is an external perspective view of the game system in accordance with one or more aspects of the invention.

FIG. 25 is an external perspective view of a slot machine in accordance with one or more aspects of the invention.

FIG. 26 is a block diagram showing an internal constitution of the game system in accordance with one or more aspects of the invention.

FIG. 27 is a block diagram showing an internal constitution of the slot machine in accordance with one or more aspects of the invention.

FIG. 28 is a block diagram showing the internal constitution of the slot machine in accordance with one or more aspects of the invention.

FIG. 29 is a flowchart of a main control process in accordance with one or more aspects of the invention.

FIG. 30 is a flowchart of a main game process in accordance with one or more aspects of the invention.

FIG. 31 is a flowchart of the server base process in accordance with one or more aspects of the invention.

FIG. 32 is an explanatory view of a lottery table in a mystery bonus in accordance with one or more aspects of the invention.

FIG. 33 is an explanatory view of display content on a large display in accordance with one or more aspects of the invention.

FIG. 34 is a flowchart of the server base process in accordance with one or more aspects of the invention.

FIG. 35 is an explanatory view of a table for number of games in accordance with one or more aspects of the invention.

FIG. 36 is a flowchart of the server lottery process in accordance with one or more aspects of the invention.

FIG. 37 is a flowchart of a first winning information sending process in accordance with one or more aspects of the invention.

FIG. 38 is an explanatory view of the table for number of games in accordance with one or more aspects of the invention.

FIG. 39 is a flowchart of a main game process of the game system in accordance with one or more aspects of the invention.

FIG. 40 is a flowchart of the server base process in accordance with one or more aspects of the invention.

FIG. 41 is an explanatory view of a table of a difference value in accordance with one or more aspects of the invention.

FIG. 42 is a flowchart of the server base process in accordance with one or more aspects of the invention.

FIG. 43 is a flowchart of a second winning information sending process in accordance with one or more aspects of the invention.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine, a server, and a game system according to one or more aspects of the invention will be described in detail with reference to the drawings based on an embodiment embodying one or more aspects of the invention. However, it is appreciated that one or more aspects of the invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU”, “processor”, and “controller” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

### First Embodiment

Hereinafter, the first embodiment embodying one or more aspects of the invention will be described with reference to the drawings. Also, winning probability of bonus may mean a probability of occurrence of the bonus.

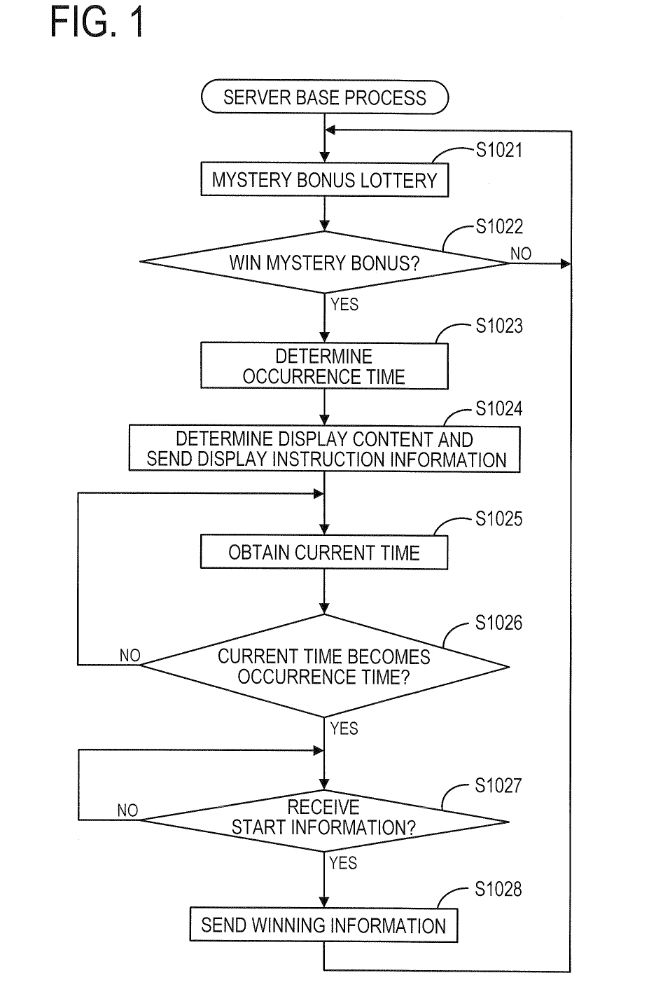

In the first embodiment, as shown in FIG. 1, in a server 1091, when a mystery bonus is won (S1022: YES), an occurrence time for the mystery bonus is determined by lottery (S1023). And a display content which will be displayed on a large-size display 1095 is determined based on the occurrence time, and display instruction information is sent to the large-size display 1095 (S1024). When a current time becomes the occurrence time (S1026: YES), winning information is sent to a slot machine in which a start operation is first executed (S1028).

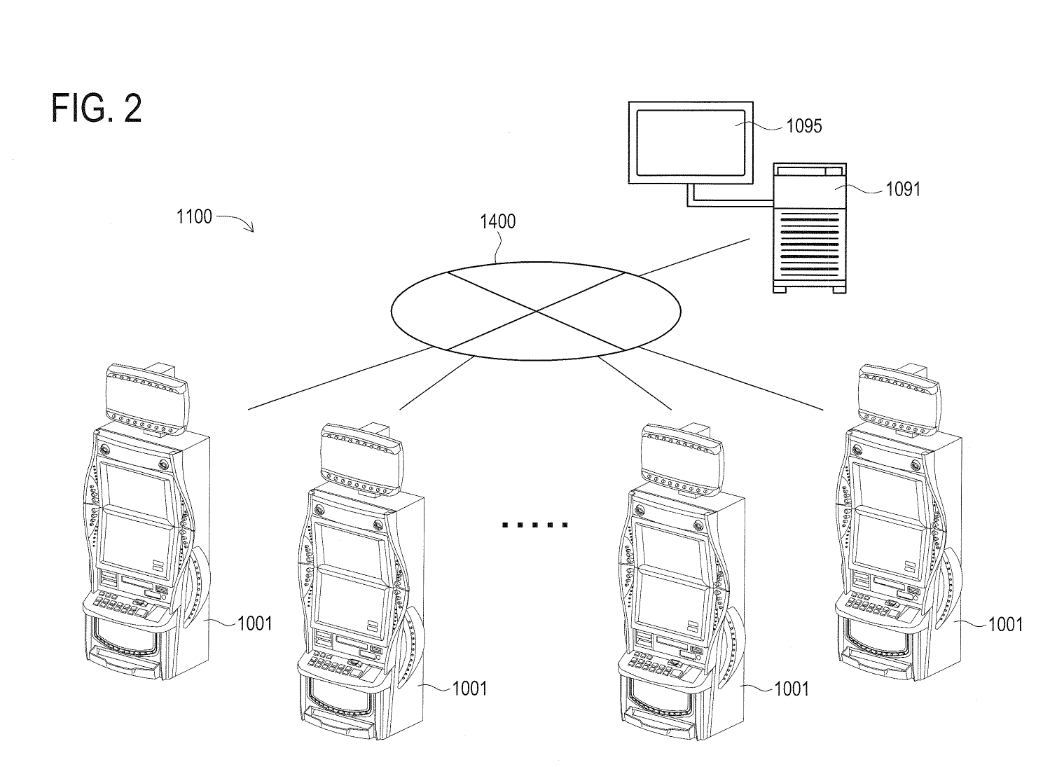

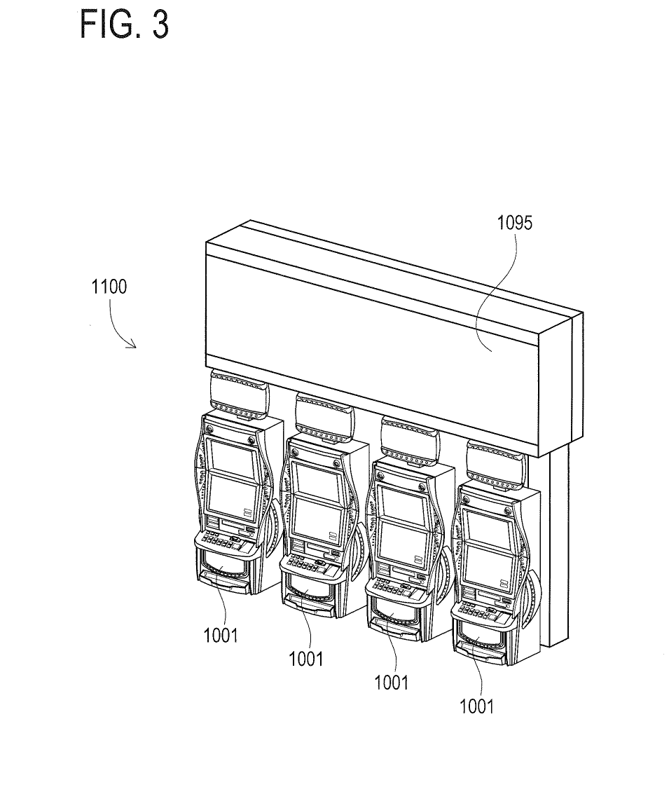

A schematic structure of a game system 1100 according to the embodiment will be explained in detail with reference to the drawings. FIG. 2 is a schematic structure view of the game system 1100 according to the embodiment. FIG. 3 is an external perspective view of the game system 1100 according to the embodiment.

As shown in FIG. 2, the game system 1100 according to the embodiment includes plural slot machines 1001, a server 1091 and a large-size display 1095. The plural slot machines 1001, a server 1091 and a large-size display 1095 are arranged in the game hall. Each of the slot machines 1001 is connected to the server 1091 via the net work 1400 so as to be capable of communicating with each other. Also a large-size display 1095 is connected to the server 1091. Here, different types of slot machine 1001 (namely slot machines with different reels, winning combinations, winning probability and the like) can be connected to the server 1091.

As shown in FIG. 3, the large-size display 1095 is provided above the plural slot machines 1001. The large-size display 1095 is a well-known large-size liquid crystal display, and displays a variety of gaming information in the game system 1100 (for example, rules of the game, game result of each slot machine 1001 and the like).

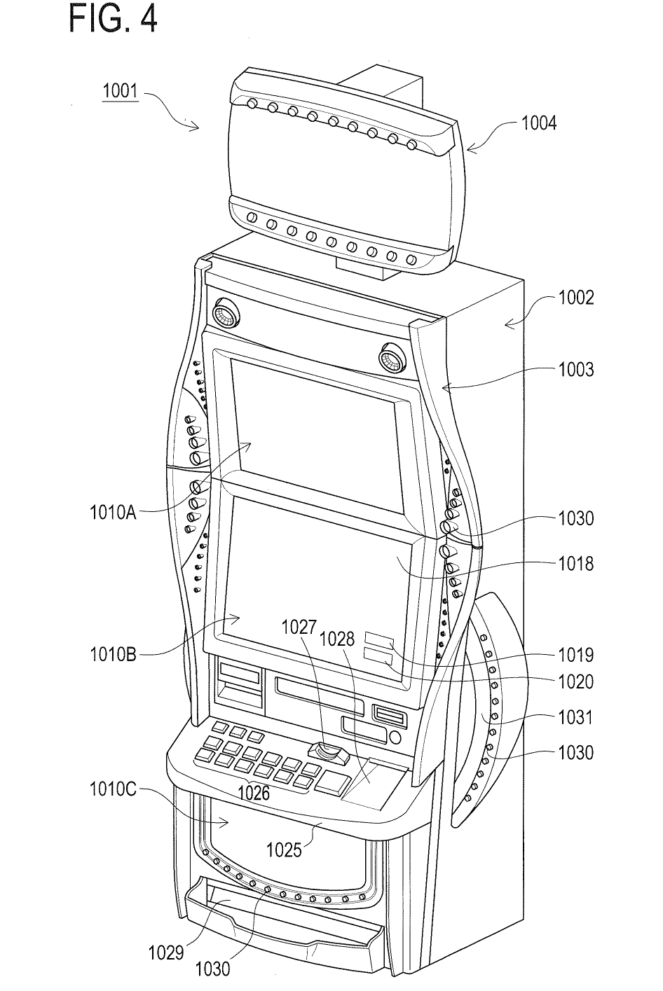

Next, the slot machine 1001 which constructs the game system 1100 according to the embodiment will be explained in detail with reference with the drawing. FIG. 4 is an external perspective view of the slot machine 1001 according to the embodiment.

The slot machine 1001 according to the embodiment is an upright type slot machine which is provided in the game hall such as the casino. The slot machine 1001 includes a cabinet 1002, a main door 1003, and a topper effect device 1004. The main door 1003 is arranged in front of the cabinet 1002. The topper effect device 1004 is arranged above the cabinet 1002.

The cabinet 1002 is a housing portion which houses the electric or the mechanic components for executing the predetermined gaming modes in the slot machine 1001.

The slot machine 1001 includes an upper display 1010A, a main display 1010B and a lower back panel 1010C at the front side of the cabinet 1002 to display various gaming information. The upper display 1010A is arranged on the upper column of the cabinet 1002, the main display 1010B is arranged on the middle column of the cabinet 1002 and the lower back panel 1010C is arranged on the lower column of the cabinet 1002.

The upper display 1010A is constructed from the liquid crystal panel. The effect images, the payout table in the game, the game rules and the like are displayed on the upper display 1010A.

The main display 1010B is constructed from the liquid crystal panel. Plural reel display portions, for example, are displayed on the main display 1010B. The variable display and the stop display of the symbol rows are displayed on each of the reel display portions. For example, three symbols are displayed on the reel display portion. In other words, symbols are displayed in a 3×5 matrix shape on the main display 1010B. The number of the reels and the number of the display symbols on each reel display portion are variable.

A touch panel 1018 is arranged on the front side of the liquid crystal panel on the main display 1010B. A player can input various instructions by operating the touch panel 1018. Also a payout number display portion 1019 and a credit number display portion 1020 are provided on the main display 1010B. The display position of the payout number display portion 1019 and the credit number display portion 1020 are arbitrary. For example, the payout number display portion 1019 and the credit number display portion 1020 may be arranged on the right lower portion of the main display 1010B. Also a bet number display portion which displays the bet number may also be provided. The payout number provided to the player may be displayed on the payout number display portion 1019. And the credit number which is presently owned by the player is displayed on the credit number display portion 1020.

The upper display 1010A and the main display 1010B, for example, are constructed from the liquid crystal panel as described above, however, this invention is not limited to the liquid crystal panel. In other words, either display portion may also be the CRT display, the plasma display, the LED display, and the other well-known display device.

The lower back panel 1010C is arranged on the lower column of the cabinet 1002, and is constructed from a plastic panel. The drawings of the characters relating to the gaming machine, the name of the gaming machine and the like are displayed on the lower back panel 1010C, and are lighted by the back lights. The lower back panel 1010C may also be the liquid crystal panel, the CRT display, the plasma display, the LED display, and the other well-known display device.

Further, the main display 1010B may also be configured as a hybrid type which is constructed from a mechanical reel and a transparent liquid crystal display device arranged in front of the mechanical reel. As a result, the symbols displayed on the mechanical reel may be visible via the transparent liquid crystal display device. Display windows which equals to the number of the mechanical reel are arranged on the transparent liquid crystal display device, so that the symbols displayed on the mechanical reel may be visible via the display windows. The slot machine using video reels will be mainly described in the below description, however, the invention may also be applied to the slot machines using the mechanical reels as much as possible. When mechanical reels are used, the rotation or the stop of the mechanical reels is controlled by a motor which is not shown.

Also, an operation table 1025 is arranged in front of the cabinet 1002. The operation table 1025 is arranged to extend forward between the main display 1010B and the lower back panel 1010C. Plural types of operation button 1026 are provided on the operation table 1025. The operation buttons 1026 include a BET button, a collect button, a start button, a CASHOUT button and the like. A coin insertion slot 1027 and a bill insertion slot 1028 are arranged on the operation table 1025. The coin insertion slot 1027 receives coins which are the gaming media to the cabinet 1002. And, the bill insertion slot 1028 is used to receive the bills to the cabinet 1002.

Further, coins, bills or electronic value (credits) which are equivalent to coins or bills are used as the gaming media in the game system 1100 (including the slot machine 1001) according to the embodiment. However, the gaming media applicable in one or more aspects of the invention are not limited to coins, bills or electronic value. For example, the gaming media may also be medals, tokens, electric moneys, and tickets.

A coin tray 1029 is provided at the bottommost of the cabinet 1002. The coin tray 1029 is used to receive the coins paid out by a hopper 1064. A light emitting portion 1030 is provided around the cabinet 1002 of the slot machine 1001. The light emitting portion 1030 is lighted up in a predetermined lighting mode when the player wins the game or during the event game. Further, a speaker 1031 is provided on the side surface of the cabinet 1002. The speaker 1031 outputs sound in accordance with the progressing of the game.

The topper effect device 1004 has a rectangular board shape, and is arranged almost parallel to the upper display 1001A.

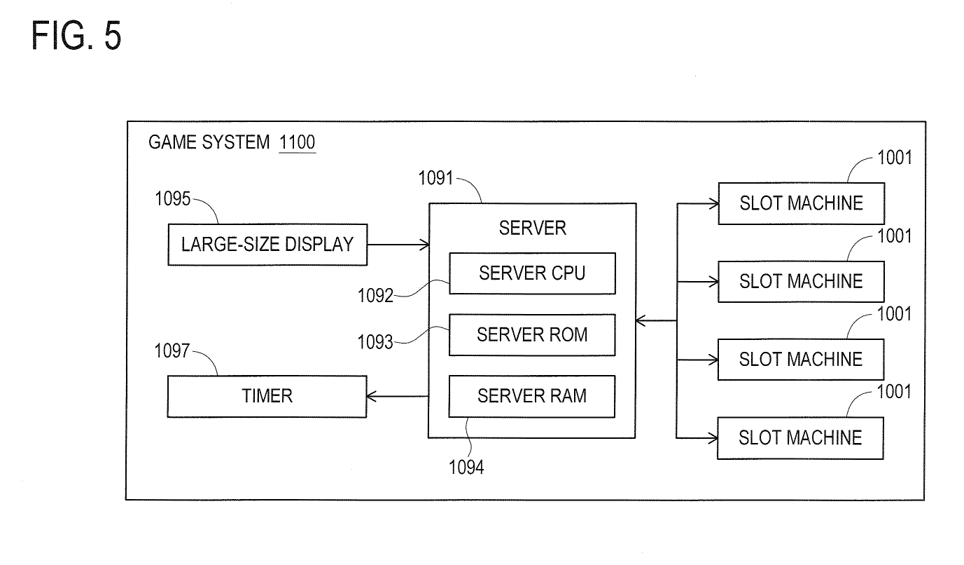

Next, the internal constitution of the game system 1100 according to the embodiment will be explained in detail with reference to the drawing. FIG. 5 is a block diagram schematically showing the internal constitution of the game system 1100.

As shown in FIG. 5, the game system 1100 includes the server 1091. The server 1091 controls the entirety of the game system 1100.

The server 1091 is constructed from a server CPU 1092, a server ROM 1093, and a server RAM 1094. The server ROM 1093 stores necessary control programs for controlling the entirety of the game system 1100 and the data tables. For example, programs for a server base process, a first winning information sending process and a second winning information sending process to be described later are stored. The server CPU 1092 executes the various control programs stored in the server ROM 1093. Also, a lottery table for the mystery bonus to be described later is stored in the server ROM 1093.

The server RAM 1094 temporarily stores the calculation results and the like when the various control programs are executed by the server CPU 1092. A table for a number of games and a table for a difference value are stored in the server RAM 1094. Also, the occurrence time to be described later is stored in the server RAM 1094.

Plural slot machines 1001 are connected to the sever 1091. The server 1091 sends and receives various data with the plural slot machines 1001.

The large-size display 1095 is connected to the server 1091. The display content of the large-size display 1095 is controlled by the server 1091. When the server 1091 sends the display instruction information, a screen corresponding to the received display instruction information is displayed.

A timer 1097 is connected to the sever 1091. The server 1091 obtains the current time data by referring to the timer 1097.

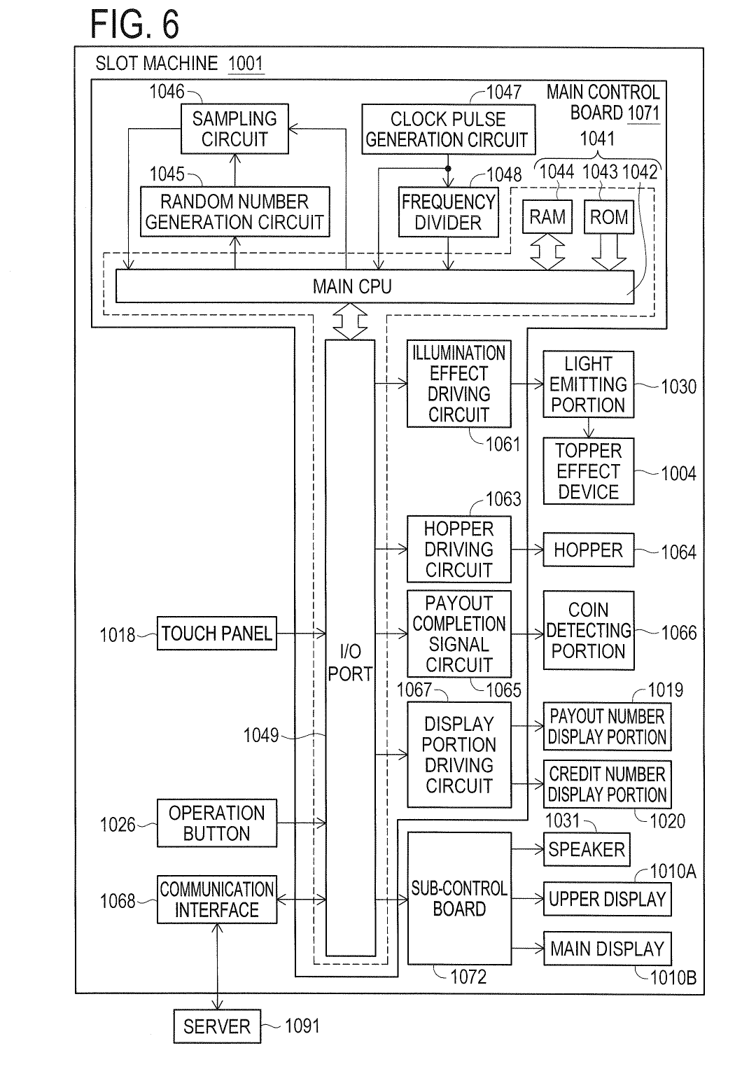

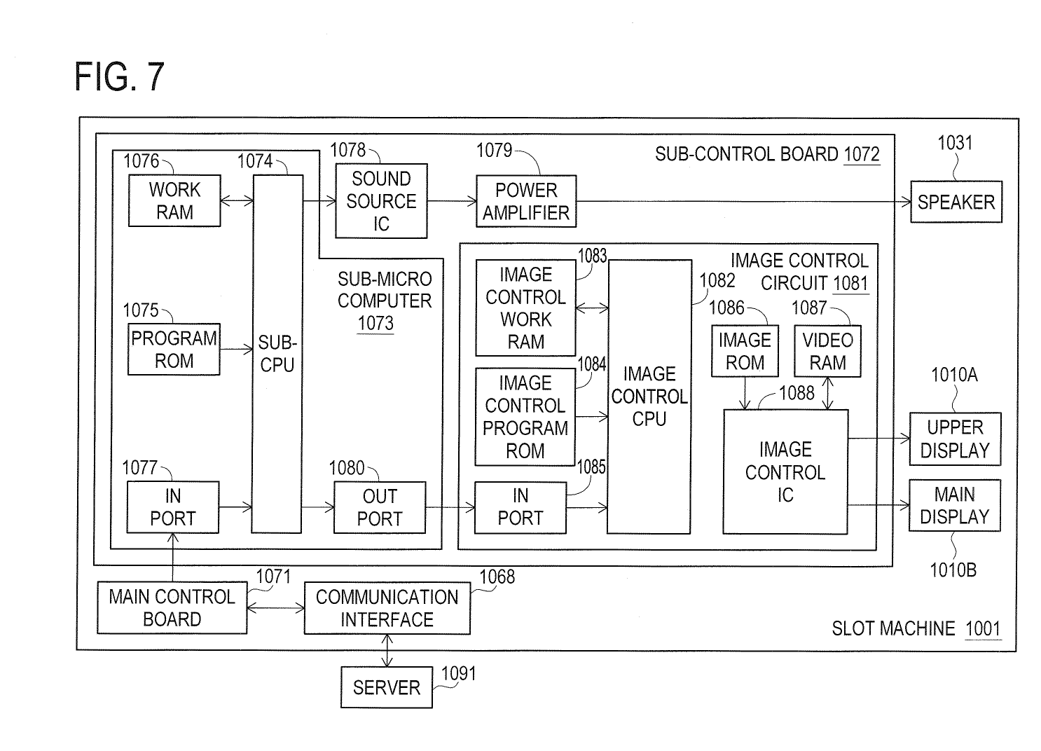

Next, the internal constitution of the slot machine 1001 according to the embodiment will be explained in detail with reference to the drawings. FIG. 6 and FIG. 7 are block diagrams showing the internal constitution of the slot machine 1001.

As shown in FIG. 6, the slot machine 1001 includes plural constitution elements around the main control board 1071.

A controller 1041 includes a main CPU 1042, a ROM 1043, a RAM 1044. The main CPU 1042 inputs or outputs signals with other constitution elements via I/O port 1049, and executes the programs stored in the ROM 1043. The main CPU 1042 serves as a control center of the slot machine 1001. The RAM 1044 stores temporarily the data and the programs when the main CPU 1042 runs. For example, the RAM 1044 temporarily stores the random number value sampled by a sampling circuit 1046 to be described later. And the identification number of the slot machine 1001 is stored in the ROM 1043 or the RAM 1044. The ROM 1043 stores the programs executed by the main CPU 1042 and the permanent data.

The main control board 1071 includes a random number generation circuit 1045, a sampling circuit 1046, a clock pulse generation circuit 1047 and a frequency divider 1048.

The random number generation circuit 1045 operates based on the instruction of the main CPU 1042, and generates a predetermined range of random numbers. The sampling circuit 1046 extracts an arbitrary random number from the random numbers generated by the random number generation circuit 1045 based on the instruction of the main CPU 1042. The sampling circuit 1046 inputs the extracted random number to the main CPU 1042. The clock pulse generation circuit 1047 generates a basic clock to run the main CPU 1042. The frequency divider 1048 divides the basic clock in a predetermined frequency, and inputs the divided signals to the main CPU 1042.

The touch panel 1018 is connected to the main control board 1071. The touch panel 1018 may specify the coordinate position of the part to which the player touches. The touch panel 1018 may determine the portion to which the player touches based on the specified coordinate position information, and determines the direction to which the touched place moves. The touch panel 1018 inputs the signal corresponding to the determination result via the I/O port 1049 to the main CPU 1042.

The operation button 1026 is connected to the main control board 1071. As described above, the operation button 1026 includes the start button, the collect button, the BET button and the like to instruct the execution of the game. When each button included in the operation buttons 1026 is pressed, the operation signal is input to the main CPU 1042 via the I/O port 1049.

A communication interface 1068 is connected to the main control board 1071. The communication interface 1068 is used to receive or send various data with the sever 1091.

The main control board 1071 also includes an illumination effect driving circuit 1061, a hopper driving circuit 1063, a payout completion signal circuit 1065 and a display portion driving circuit 1067.

The illumination effect driving circuit 1061 outputs effect signals to the above-mentioned light emitting portion 1030 and the topper effect device 1004. And the topper effect device 1004 is serially connected to the illumination effect driving circuit 1061 through light emitting portions 1030. When the effect signal is input, the light emitting portions 1030 and the topper effect device 1004 emit light in a predetermined light emitting mode. As a result, the slot machine 1001 executes light emitting effect in accordance with the progressing of the game.

The hopper driving circuit 1063 drives the hopper 1064 based on the control of the main CPU 1042. The hopper 1064 executes the payout of coins, and thereby, coins are paid out to the coin tray 1029. The display portion driving circuit 1067 executes the display control of various display portions such as the payout number display portion 1019, the credit number display portion 1020 and the like.

A coin detecting portion 1066 is connected to the payout completion signal circuit 1065. The coin detecting portion 1066 calculates the number of the coins paid out by the hopper 1064. The coin detecting portion 1066 inputs the data of the number of coins which is calculated to the payout completion signal circuit 1065. The payout completion signal circuit 1065 determines whether the predetermined number of coins is paid out or not based on the data of the number of coins input by the coin detecting portion 1066. When the coins with a predetermined number are all paid out, the signal indicating the completion of the coins is input to the main CPU 1042 by the payout completion signal circuit 1065.

A sub-control board 1072 is connected to the main control board 1071. The sub-control board 1072 is formed on a circuit board different from that of the main control board 1071. The display control of the upper display 1010A, the main display 1010B and the output control of sound by the speaker 1031 are executed by the sub-control board 1072, based on the commands input from the main control board 1071.

As shown in FIG. 7, the sub-control board 1072 includes a microcomputer 1073 (abbreviated as “sub-microcomputer” hereinafter) as a main constitution element. The sub-microcomputer 1073 includes a sub-CPU 1074, a program ROM 1075, a work RAM 1076, an IN port 1077 and an OUT port 1080. The sub-CPU 1074 executes the control operations based on the control orders (commands) sent from the main control board 1071. The program ROM 1075 stores the control programs executed by the sub-CPU 1074. The work RAM 1076 is configured as a temporary storing device when the above control programs are executed by the sub-CPU 1074.

The sub-control board 1072 executes the random number sampling on the running program of the sub-CPU 1074. As a result, the sub-control board 1072 may execute the same processes as the processes executed by the clock pulse generation circuit 1047, the frequency divider 1048, the random number generation circuit 1045, and the sampling circuit 1046 in the main control board 1071.

The sub-control board 1072 includes a sound source IC 1078, a power amplifier 1079 and an image control circuit 1081. The sound source IC 1078 controls the sound output from the speaker 1031. The power amplifier 1079 is used as an amplifier for the output of the sound. And the image control circuit 1081 is running as the display control device of the upper display 1010A and the main display 1010B.

The image control circuit 1081 includes an image control CPU 1082, an image control work RAM 1083, an image control program ROM 1084, an image ROM 1086, a video RAM 1087 and an image control IC 1088. The image control CPU 1082 determines the images displayed on the upper display 1010A and the main display 1010B based on the parameters set by the sub-microcomputer 1073 and the image control programs.

The image control programs regarding to the display of the upper display 1010A and the main display 1010B and a variety of the selection tables are stored in the image control program ROM 1084. The image control work RAM 1083 serves as a temporary storing device when the image control programs are executed by the image control CPU 1082. IN port 1085 is connected to the OUT port 1080. Images corresponding to the content determined by the image control CPU 1082 are formed by the image control IC 1088, and are output to the upper display 1010A and the main display 1010B. The dot data used to form images are stored in the image ROM 1086. The video RAM 1087 serves as a temporary storing device when the images are formed by the image control IC 1088.

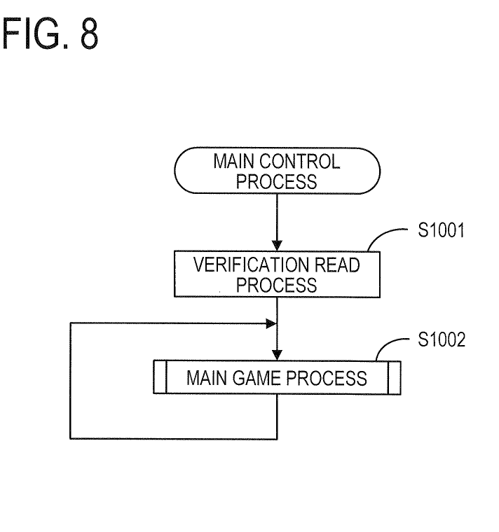

Next, the main control process executed in slot machine 1001 according to the embodiment will be explained with reference to the drawing. FIG. 8 is a flowchart of the main control process. The programs for executing the main control process are stored in the ROM 1043 of the slot machine 1001, and are executed by the main CPU 1042.

When the power switch is ON (the power is turned ON), the main control board 1071 and the sub-control board 1072 are activated respectively, the controller 1041 executes the verification read process of S1001. In the verification read process S1001, the main CPU 1042 executes the BIOS stored in the ROM 1043, and extracts the compressed data incorporated in the BIOS to the RAM 1044. And once the BIOS extracted in the RAM 1044 is executed, diagnosis of the variety of peripheral devices and initialization are executed by the main CPU 1042. Further, the CPU 1042 writes the game programs from the ROM 1043 to the RAM 1044. And also the CPU 1042 executes the certification process to each program during the execution of the initial setting process.

In S1002, the game program and the like are read out from the RAM 1044 in sequence and are executed so as to progress the main game process. The game in the slot machine 1001 according to the embodiment is progressed by the execution of the main game process. And, the main game process is repeated to be executed during the power of the slot machine 1001 is supplied.

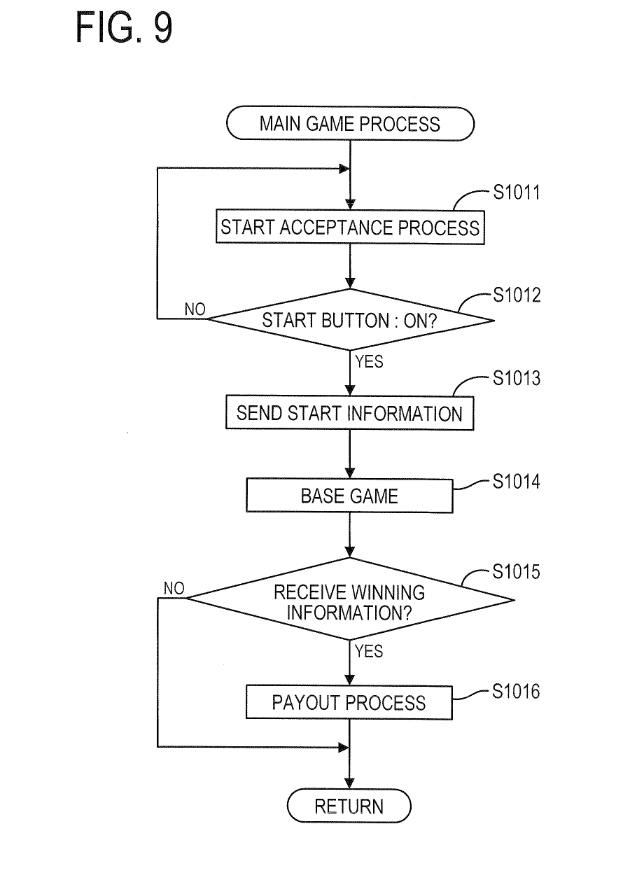

Next, the main game process will be described in detail with reference to the drawing. FIG. 9 is a flowchart of the main game process.

In S1011, the start acceptance process is executed. In the start acceptance process, after the predetermined initial setting is executed, the setting of the bet number and the like are executed. And, the input of coins is executed by the player from the coin insertion slot 1027. The bet operation using the operation button 1026 is also executed. The number of the coins inserted from the coin insertion slot 1027 or the bet operation using the operation button 1026 is detected respectively.

In S1012, it is determined whether or not the start button is operated. The determination whether the start button is operated is executed based on whether or not the input signal is received from the start switch.

If it is determined that the start button is not operated (S1012: NO), the game returns to the start acceptance process. The operation such as correction of the bet number is possible at this time. On the other hand, if it is determined that the start button is operated (S1012: YES), the bet number which is set is deducted from the credits owned by the player, and the subtraction result is stored in the RAM 1044 as the betting information. And then, the game proceeds to S1013.

In S1013, start information is sent to the server 1091. The start information includes a bet amount and the identification number (ID) of slot machine 1001.

In S1014, a base game is progressed. In the base game, for example, the symbol rows are variably displayed on the symbol display portion, and then the symbol rows are stopped and displayed. Awards are provided based on the symbol combination of the symbols stopped and displayed. As the base game, various well-known games may be executed. And, a predetermined award may be provided based on the game result. And then the game proceeds to S1015.

In S1015, it is determined whether or not the winning information is received from the server 1091. If it is determined that the winning information is not received from the server 1091 (S1015: NO), the main game process is terminated. On the other hand, if it is determined that the winning information is received from the server 1091 (S1015: YES), the game proceeds to S1016. The mystery bonus is realized by receiving the winning information.

In S1016, a payout process is executed. In the payout process, gaming medium may be paid out based on a payout amount included in the winning information.

Next, a server base process executed in the server 1091 will be described. FIG. 1 is a flowchart of the server base process. Programs for executing the server base process are stored in the server ROM 1093 of the server 1091, and are executed by the server CPU 1092.

In S1021, a lottery for the mystery bonus is conducted. That is, it is determined whether or not the mystery bonus is won by lottery. The mystery bonus lottery is conducted in a predetermined time period (for example, 10 seconds).

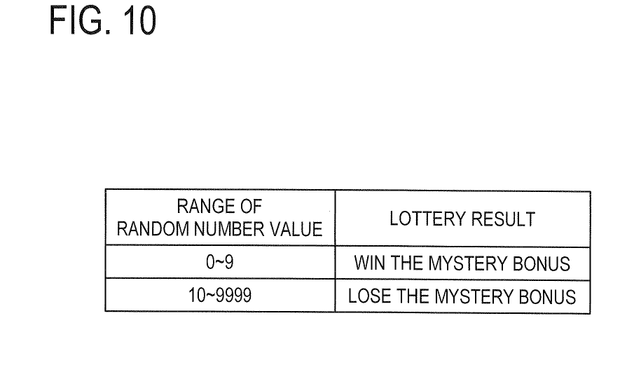

Hereinafter, a lottery method for the mystery bonus will be described. FIG. 10 is one example of a lottery table of the mystery bonus. The lottery table is stored in the server ROM 1093, and it is write in the server RAM 1094 and used. A range for the random number value is 0 through 9999, and when any random number value in the range of 0 through 9 is selected, the mystery bonus is won. Further, the range for the random number value and/or the correspondence relationship between the random number value and a result of lottery may be set appropriately.

In S1022, it is determined whether or not the mystery bonus is won. If it is determined that the mystery bonus is not won (S1022: NO), the game returns to S1021. On the other hand, if it is determined that the mystery bonus is won (S1022: YES), the game proceeds to S1023.

In S1023, the occurrence time is determined by lottery. For example, when the mystery bonus is won at 2:30 PM, the occurrence time may be set at any time between 2:30 PM to 4:30 PM. In other words, the occurrence time may be determined by lottery in a time period of 2 hours from the time when the mystery bonus is won. Also a time period may be determined among 0 through 2 hours, and the occurrence time may be determined by adding the time period to the time when the mystery bonus is won. The determined occurrence time is stored in the server RAM 1094. And the range of the occurrence time may be set appropriately.

In S1024, display content to be displayed on the large-size display 1095 is determined. For example, in S1023, when the occurrence time is determined at 3:15 PM, the display content is determined as “Bonus Announcement!! A mystery bonus will occur at any slot machine by 3:30 PM”. It means that the time included in the display content is a time that is later than the occurrence time.

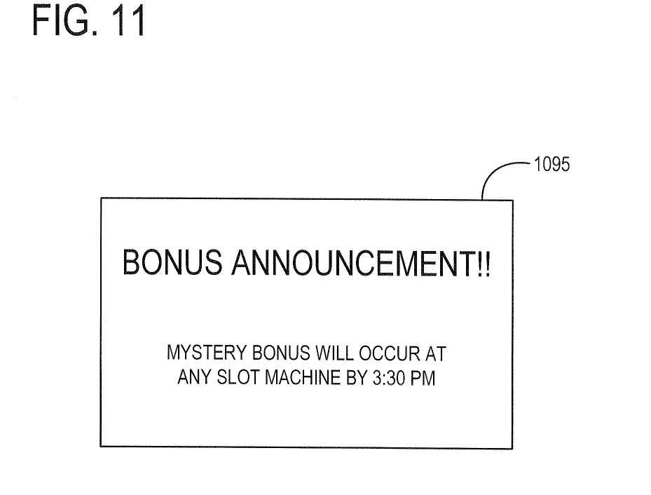

Then, display instruction information including the determined display content will be sent to the large-size display 1095. FIG. 11 is one example of display content displayed on the large-size display 1095.

In S1025, a current time is obtained. Here, the timer 1097 is referred.

In S1026, it is determined whether or not the current time becomes the occurrence time. If it is determined that the current time has not become the occurrence time (S1026: NO), the game returns to S1025. On the other hand, if it is determined that the current time becomes the occurrence time (S1026: YES), the game shifts to S1027.

When the process is in S1025 or in S1026, the mystery bonus is won inside the server 1091, however, the mystery bonus is not yet realized in any of the slot machines 1001 (namely, the server 1091 is in a stock state).

In S1027, it is determined whether or not start information is received from any of the slot machines 1001. If it is determined that the start information is not received from any of the slot machines 1001 (S1027: NO), the game returns to S1027. In other words, the process will wait in S1027 until the start information is received from any of the slot machines 1001.

On the other hand, if it is determined that the start information is received from any of the slot machines 1001 (S1027: YES), the game proceeds to S1028.

In S1028, the winning information is sent to the slot machine which has sent the start information first. That is, the mystery bonus is realized in the slot machine which has sent the start information first. The winning information includes information indicating that the mystery bonus is realized and information indicating payout amount. The payout amount may be set appropriately. When the winning information is sent, the server 1091 starts to determine a next mystery bonus by lottery.

According to the first embodiment described above, when the mystery bonus is won inside the server 1091, the occurrence time for the mystery bonus is determined by the server 1091, the display content is determined based on information of the determined occurrence time, and the display content is displayed on the large-size display 1095. When the current time becomes the occurrence time, the mystery bonus is provided to the slot machine 1001 in which the start operation is first conducted since then.

Herewith, the entertainment aspect will be enhanced and one or more aspects of the invention can attract more players. Also, since the occurrence of the mystery bonus is announced on the large-size display 1095, vacant slot machines 1001 can attract the players. Accordingly, a working ratio of the slot machines 1001 may be increased. That is, a playing time of the slot machine 1001 may be enhanced.

### Second Embodiment

Next, a second embodiment embodying one or more aspects of the invention will be described with reference to the drawings. Since the main control program and the main game program are the same as those in the first embodiment, description will be omitted here.

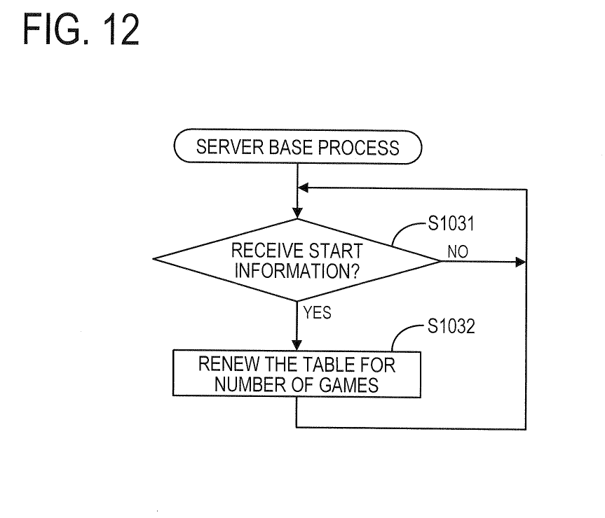

The server base process in the second embodiment will be described with reference to the drawing. FIG. 12 is a flowchart of the server base process.

In S1031, it is determined whether the start information is received from any of the slot machines 1001. If it is determined that the start information is not received from any of the slot machines 1001 (S1031: NO), the game returns to S1031.

On the other hand, if it is determined that the start information is received from any of the slot machines 1001 (S1031: YES), the game proceeds to S1032. In S1032, a table for the number of games is renewed.

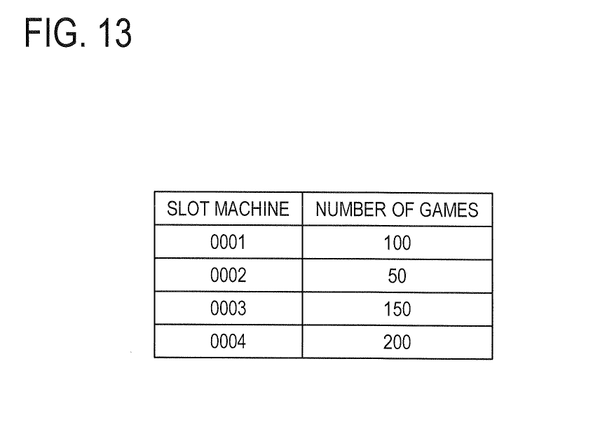

FIG. 13 shows one example of a table for the number of games during the time period from the realized time of last mystery bonus to the occurrence time of current mystery bonus. The table for the number of games is stored in the server RAM 1094.

FIG. 13 shows that a slot machine having ID “0001”, a slot machine having ID “0002”, a slot machine having ID “p0003”, and a slot machine having ID “0004” are connected to the server 1091. The number of games in each slot machine is 100, 50, 150 and 200 respectively.

In the state shown in FIG. 13, for example, if the start information is received from the slot machines having ID “p0002”, the number of games corresponding to the slot machines having ID “0002” is renewed from 50 to 51.

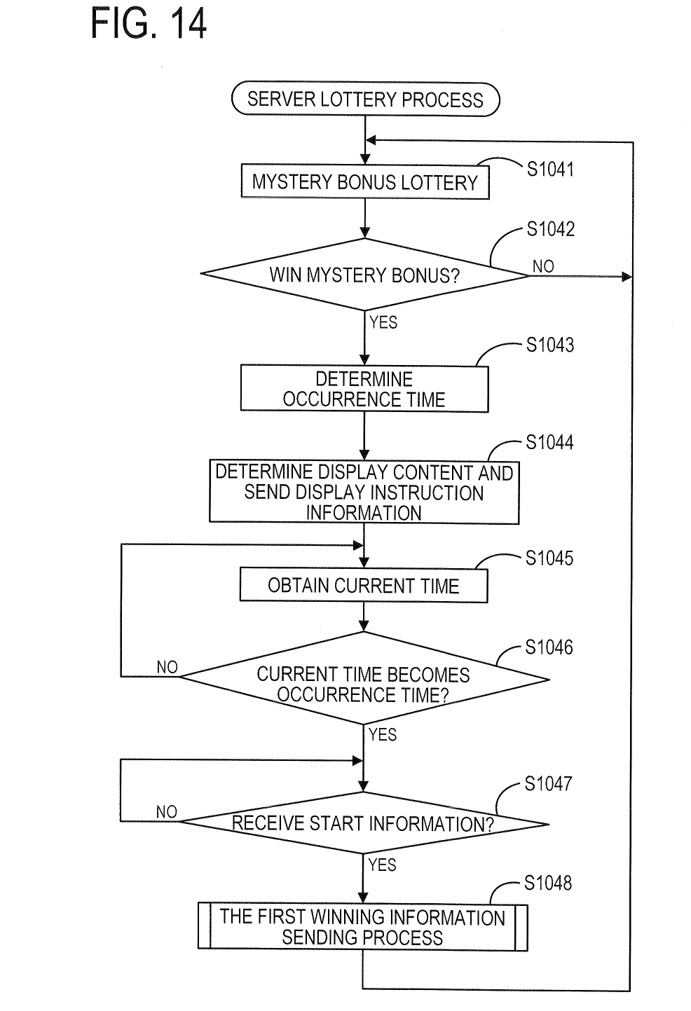

Next, the server lottery process executed in the server 1091 will be described. FIG. 14 is a flowchart of the server lottery process. Programs to implement the server lottery process are stored in the server ROM 1093 of the server 1091, and are executed by the server CPU 1092. The mystery bonus lottery is conducted in a predetermined time period (for example, every 10 seconds). Further, the server lottery process may be executed parallel to the above server base process.

Since the processes of S1041 through S1047 are the same as the processes of S1021 to S1027 in the first embodiment (see FIG. 1), description will be omitted.

When the process is in S1045 or in S1046, the mystery bonus is won inside the server 1091, however, the mystery bonus is not yet realized in any of the slot machines 1001 (namely, the server 1091 is in a stock state).

In S1048, the first winning information sending process is executed.

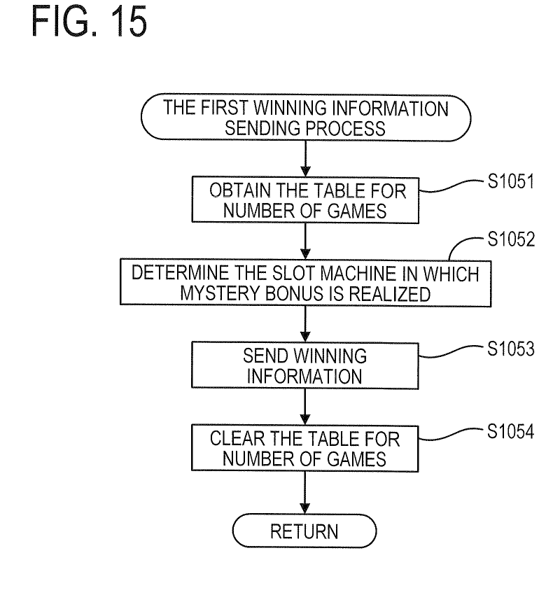

Hereinafter, the first winning information sending process will be described. FIG. 15 is a flowchart of the first winning information sending process.

In S1051, the table for the number of games is obtained. Here, the server RAM 1094 is referred.

In S1052, a slot machine in which the mystery bonus is realized is determined. The determination method of the slot machine in which the mystery bonus is realized will be described.

First, winning probability of each slot machine 1001 will be determined based on contents of the table for the number of games.

For example, in a state shown in FIG. 13, ratio of the number of games in each slot machine of the slot machine having ID “0001”, the slot machine having ID “0002”, the slot machine having ID “0003”, and the slot machine having ID “0004”, is [2:1:3:4]. Also, the winning probability is determined in accordance with the ratio of the number of games.

As a result, the winning probability of the slot machine having ID “0001” may be defined as 20%.

The winning probability of the slot machine having ID “0002” may be defined as 10%.

The winning probability of the slot machine having ID “0003” may be defined as 30%.

The winning probability of the slot machine having ID “0004” may be defined as 40%.

That is, the slot machine with a larger number of games has a higher winning probability. In other words, as the number of games is larger, as the winning probability is higher.

The corresponding relationship between the number of games and the winning probability may be determined appropriately.

After that, the slot machine in which the mystery bonus is realized will be determined based on the determined winning probability.

In S1053, the winning information is sent to the slot machine in which the mystery bonus is realized. In other words, the mystery bonus is realized in the slot machine which received the start information. The winning information includes information indicating that the mystery bonus is realized and information indicating a payout amount.

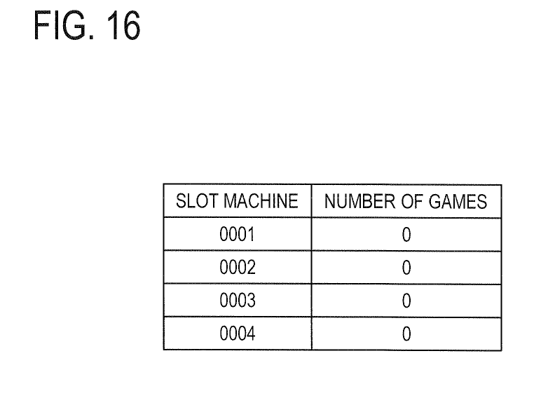

In S1054, the number of games of each slot machine 1001 in the table for the number of games is cleared. FIG. 16 shows contents of the table for the number of games which has been cleared.

According to the second embodiment described above, when the mystery bonus is won inside the server 1091, the occurrence time for the mystery bonus is determined by the server 1091, the display content is determined based on information of the determined occurrence time, and the display content is displayed on the large-size display 1095. When the current time becomes the occurrence time, the slot machine in which the mystery bonus is realized will be determined by lottery. Here, the slot machine in which the mystery bonus is realized, will be determined based on the number of games of each slot machine during the time period from the realized time of last mystery bonus to the occurrence time of current mystery bonus. Also, the slot machine in which the mystery bonus is realized may be determined based on the number of games of each slot machine during the time period from the winning time of current mystery bonus to the occurrence time of current mystery bonus.

Herewith, the entertainment aspect will be enhanced and one or more aspects of the invention can attract more players. Also, since as the number of games is larger, as the winning probability of the mystery bonus is higher, the player tends to play more games. Accordingly, a playing time of each of the slot machines 1001 may be enhanced.

Also, since the occurrence of the mystery bonus is announced on the large-size display 1095, vacant slot machines 1001 can attract the players. Accordingly, a working ratio of the slot machines 1001 may be increased. That is, a playing time of the slot machine 1001 may be enhanced.

### Third Embodiment

Next, a third embodiment embodying one or more aspects of the invention will be described with reference to the drawings. Since the main control program executed in slot machine 1001 is the same as that in the first embodiment, description will be omitted here.

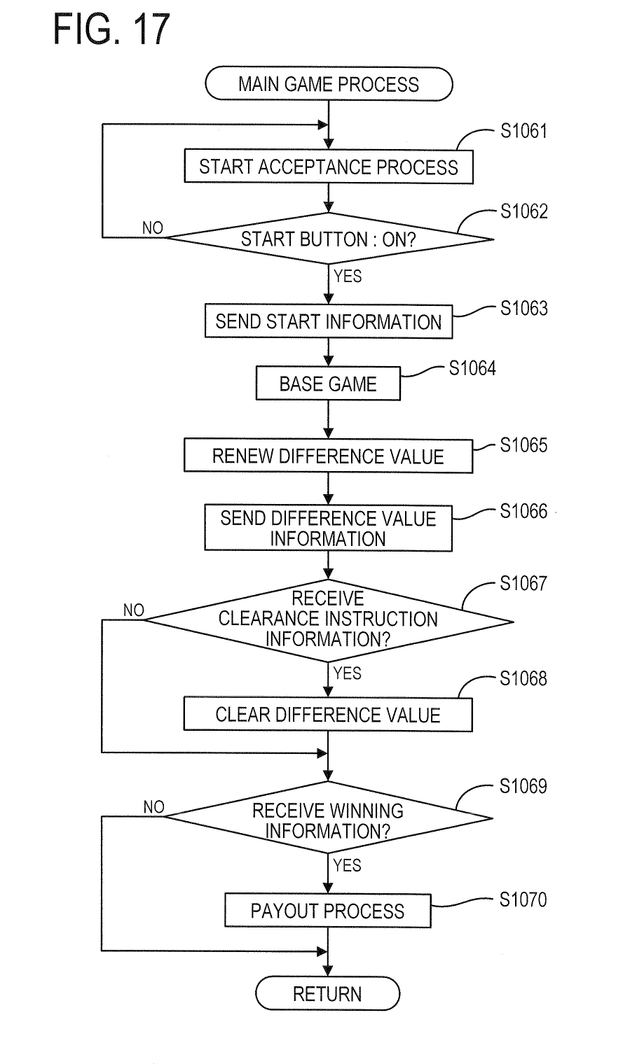

Next, the main game process in the third embodiment will be described with reference to the drawing. FIG. 17 is a flowchart of the main game process.

Since the processes of S1061 to S1064 are the same as the processes of S1011 to S1014 in the first embodiment (see FIG. 9), description will be omitted.

In S1065, the difference value is renewed. The difference value is increased by the bet amount set in the bet operation of S1061, and is decreased by the payout amount of the gaming medium. In other words, when the payout amount to the player is smaller, the difference value becomes larger. When the payout amount to the player is larger, the difference value becomes smaller. That is, as the payout amount is smaller, as the difference value is larger. Also, as the payout amount is larger, as the difference value is smaller.

Also, the renewal of the difference value may be executed when the start button is turned ON, and when the gaming media are paid out in the base game.

In S1066, difference value information is sent to the server 1091. The difference value information includes the ID and the difference value of the slot machine 1001. The timing to send the difference value information to the server 1091 may be set at a different timing.

In S1067, it is determined whether or not clearance instruction information is received from the server 1091. If it is determined that the clearance instruction information is not received from the server 1091 (S1067: NO), the game proceeds to S1069. On the other hand, if it is determined that the clearance instruction information is received from the server 1091 (S1067: YES), the game proceeds to S1068. When the mystery bonus is realized in any of the slot machines 1001, the clearance instruction information is received.

In S1068, the difference value stored in the server RAM 1094 is cleared.

In S1069, it is determined whether or not the winning information is received from the server 1091. If it is determined that the winning information is not received from the server 1091 (S1069: NO), the main game process is terminated. On the other hand, if it is determined that the winning information is received from the server 1091 (S1069: YES), the game proceeds to S1070.

In S1070, the payout process is executed. In the payout process, gaming media are paid out based on payout amount included in the winning information.

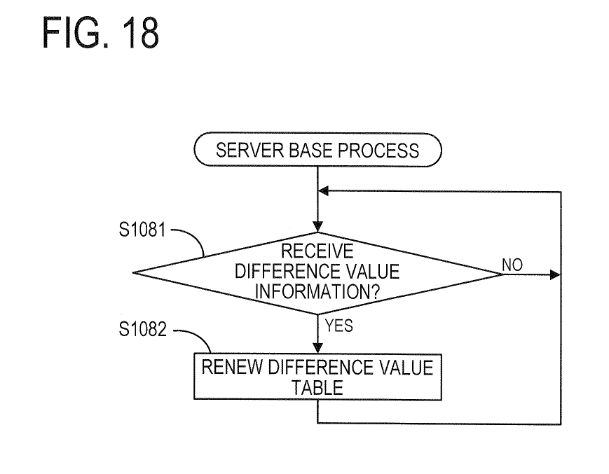

Next, the server base process in the third embodiment will be described with reference to the drawing. FIG. 18 is a flowchart of the server base process.

In S1081, it is determined whether or not the difference value information is received from any slot machine 1001. If it is determined that the difference value information is not received from any slot machine 1001 (S1081: NO), the game returns to S1081.

On the other hand, if it is determined that the winning information is received from the server 1091 (S1081: YES), the game proceeds to S1082.

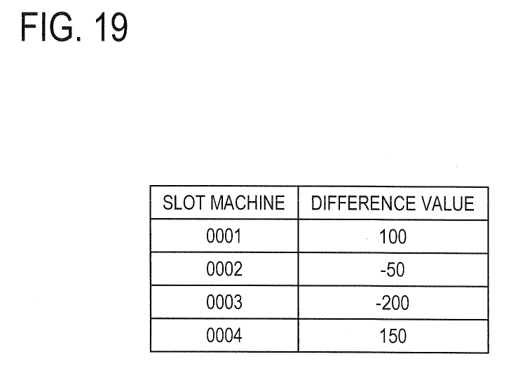

In S1082, a difference value table is renewed. The difference value table is stored in the server RAM 1094. FIG. 19 shows one example of a difference value table. FIG. 19 shows that the slot machine having ID “0001”, the slot machine having ID “0002”, the slot machine having ID “0003”, and the slot machine having ID “0004” are connected to the server 1091.

The difference value of each slot machine during the time period from the realized time of last mystery bonus to the occurrence time of current mystery bonus, is “100 denominations”, “−50 denominations”, “−200 denominations”, “150 denominations”. Also, 1 denomination may be set appropriately. For example, 1 denomination may be defined as 1$, or 1 denomination may be defined as 25¢.

In a state shown in FIG. 19, for example, when the difference value information including difference value of “10” is received from the slot machine having ID “0002”, the difference value corresponding to the slot machine having ID “0002” is renewed from “−50” to “−40”.

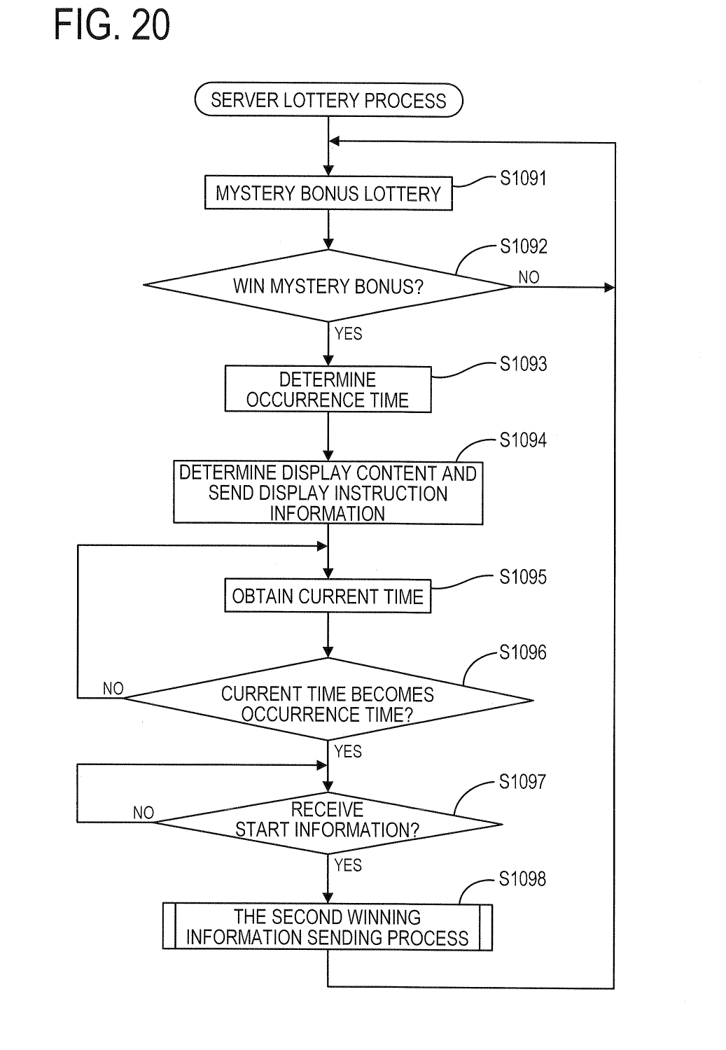

Next, the server lottery process executed in the server 1091 will be described. FIG. 20 is a flowchart of the server lottery process. Programs to implement the server lottery process are stored in the server ROM 1093 of the server 1091, and are executed by the server CPU 1092. The mystery bonus lottery is conducted in a predetermined time period (for example, every 10 seconds). Further, the server lottery process may be executed parallel to the above server base process.

Since the processes of S1091 to S1097 are the same as the processes of S1021 to S1027 in the first embodiment (see FIG. 1), description will be omitted.

During the process between S1095 and S1096, the mystery bonus is won inside the server 1091, however, the mystery bonus is not yet realized in any of the slot machines 1001 (namely, the server 1091 is in a stock state).

In S1098, the second winning information sending process is executed.

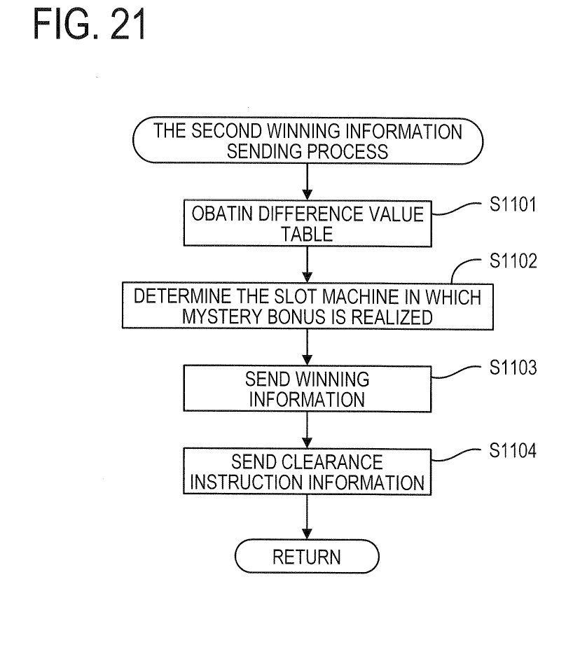

Hereinafter, the second winning information sending process will be described. FIG. 21 is a flowchart of the second winning information sending process.

In S1101, the table of the difference value is obtained. Here, the server RAM 1094 is referred.

In S1102, a slot machine in which the mystery bonus is realized is determined. The determination method of the slot machine in which the mystery bonus is realized will be described.

First, winning probability of each slot machine 1001 will be determined based on contents of the table of the difference value.

For example, in the state shown in FIG. 19, the winning probability of the slot machine having ID “0001” may be defined as 30%.

The winning probability of the slot machine having ID “0002” may be defined as 20%.

The winning probability of the slot machine having ID “0003” may be defined as 10%.

The winning probability of the slot machine having ID “0004” may be defined as 40%.

That is, the slot machine with a larger difference value has a higher winning probability. In other words, the slot machine having a less payout amount to the player, the winning probability is higher.

Namely, as the difference value is larger, as the winning probability is higher. Also, as the payout amount is smaller, as the winning probability is higher.

The corresponding relationship between the number of games and the winning probability may be determined appropriately.

After that, the slot machine in which the mystery bonus is realized is determined based on the determined winning probability.

In S1103, the winning information is sent to the slot machine in which the mystery bonus is realized. In other words, the mystery bonus is realized in the slot machine which received the start information. The winning information includes information indicating that the mystery bonus is realized and information indicating a payout amount.

In S1104, the clearance instruction information will be sent to each slot machine 1001.

According to the third embodiment described above, when the mystery bonus is won inside the server 1091, the occurrence time for the mystery bonus is determined by the server 1091, the display content is determined based on the determined occurrence time, and the display content is displayed on the large-size display 1095. When the current time becomes the occurrence time, the slot machine in which the mystery bonus is realized will be determined by lottery. Here, the slot machine in which the mystery bonus is realized will be determined based on the difference value between the bet amount and the payout amount of each slot machine during the time period from the realized time of last mystery bonus to the occurrence time of current mystery bonus. Also, the slot machine in which the mystery bonus is realized may be determined based on difference value between the bet amount and the payout amount of each slot machine during the period from current mystery bonus winning time to the occurrence time of current mystery bonus.

Herewith, the entertainment aspect will be enhanced and one or more aspects of the invention can attract more players. Also, since as the payout amount is smaller, as the winning probability of the mystery bonus is higher, the player who put in more credits may anticipate the mystery bonus more.

Also, since the occurrence of the mystery bonus is announced on the large-size display 1095, vacant slot machines 1001 can attract the players. Accordingly, a working ratio of the slot machines 1001 may be increased. That is, a playing time of the slot machine 1001 may be enhanced.

### Fourth Embodiment

Next, a fourth embodiment embodying one or more aspects of the invention will be described with reference to the drawings. Also, winning probability of bonus may mean a probability of occurrence of the bonus.

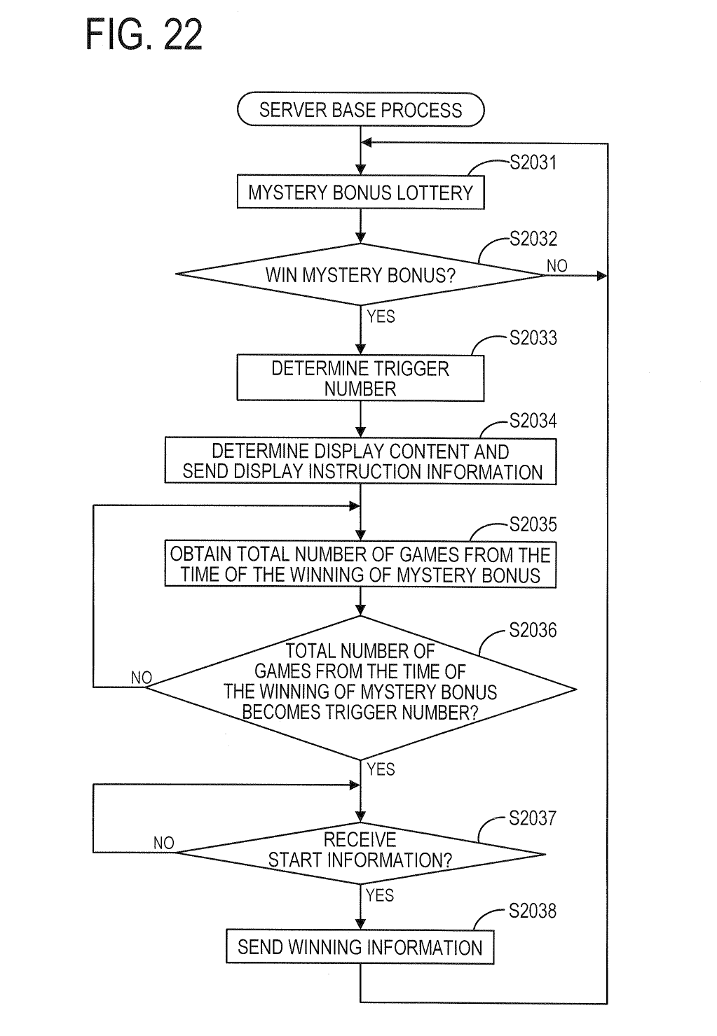

In the fourth embodiment, as shown in FIG. 22, in a server 2091, when a mystery bonus is won (S2032: YES), a trigger number for the mystery bonus is determined by lottery (S2033). And display content which will be displayed on a large-size display 2095 is determined based on the trigger number, and display instruction information is sent to the large-size display 2095 (S2034). When a total number of games becomes the trigger number (S2036: YES), winning information is sent to a slot machine in which a start operation for a game is first executed (S2038).

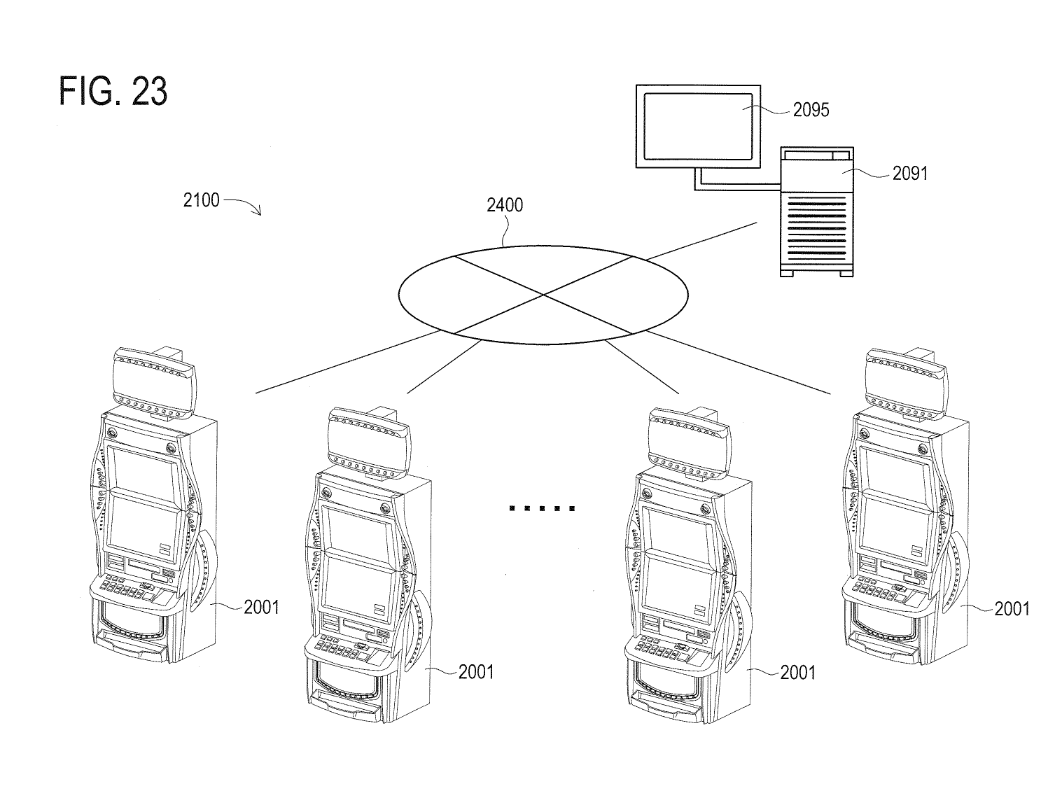

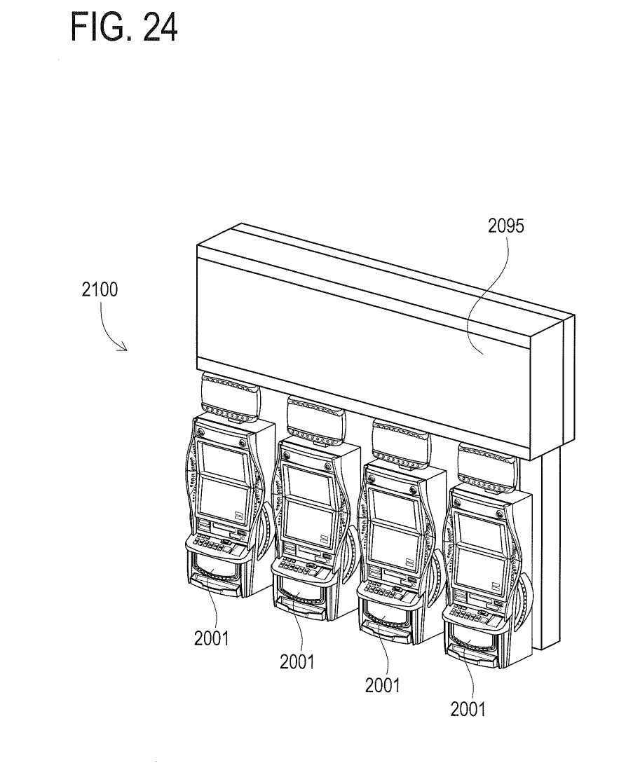

A schematic structure of a game system 2100 according to the embodiment will be explained in detail with reference to the drawings. FIG. 23 is a schematic structure view of the game system 2100 according to the embodiment. FIG. 24 is an external perspective view of the game system 2100 according to the embodiment.

As shown in FIG. 23, the game system 2100 according to the embodiment includes plural slot machines 2001, a server 2091 and a large-size display 2095. The plural slot machines 2001, a server 2091 and a large-size display 2095 are arranged in the game hall. Each of the slot machines 2001 is connected to the server 2091 via the net work 2400 so as to be capable of communicating with each other. Also a large-size display 2095 is connected to the server 2091. Here, different types of slot machine 2001 (namely slot machines with different reels, winning combinations, winning probability and the like) can be connected to the server 2091.

As shown in FIG. 24, the large-size display 2095 is provided above the plural slot machines 2001. The large-size display 2095 is a well-known large-size liquid crystal display, and displays a variety of gaming information in the game system 2100 (for example, rules of the game, game result of each slot machine 2001 and the like).

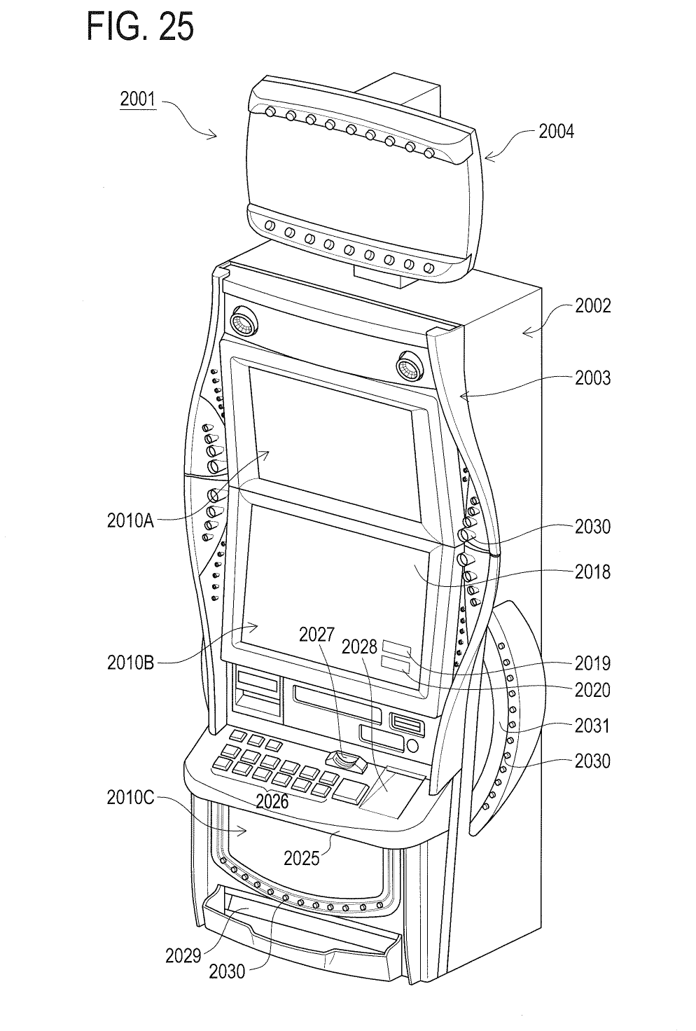

Next, the slot machine 2001 which constructs the game system 2100 according to the embodiment will be explained in detail with reference with the drawing. FIG. 25 is an external perspective view of the slot machine 2001 according to the embodiment.

The slot machine 2001 according to the embodiment is an upright type slot machine which is provided in the game hall such as the casino. The slot machine 2001 includes a cabinet 2002, a main door 2003, and a topper effect device 2004. The main door 2003 is arranged in front of the cabinet 2002. The topper effect device 2004 is arranged above the cabinet 2002.

The cabinet 2002 is a housing portion which houses the electric or the mechanic components for executing the predetermined gaming modes in the slot machine 2001.

The slot machine 2001 includes an upper display 2010A, a main display 2010B and a lower back panel 2010C at the front side of the cabinet 2002 to display various gaming information. The upper display 2010A is arranged on the upper column of the cabinet 2002, the main display 2010B is arranged on the middle column of the cabinet 2002 and the lower back panel 2010C is arranged on the lower column of the cabinet 2002.

The upper display 2010A is constructed from the liquid crystal panel. The effect images, the payout table in the game, the game rules and the like are displayed on the upper display 2010A.

The main display 2010B is constructed from the liquid crystal panel. Plural reel display portions, for example, are displayed on the main display 2010B. The variable display and the stop display of the symbol rows are displayed on each of the reel display portions. For example, three symbols are displayed on the reel display portion. In other words, symbols are displayed in a 3×5 matrix shape on the main display 2010B. The number of the reels and the number of the display symbols on each reel display portion are variable.

A touch panel 2018 is arranged on the front side of the liquid crystal panel on the main display 2010B. A player can input various instructions by operating the touch panel 2018. Also a payout number display portion 2019 and a credit number display portion 2020 are provided on the main display 2010B. The display position of the payout number display portion 2019 and the credit number display portion 2020 are arbitrary. For example, the payout number display portion 2019 and the credit number display portion 2020 may be arranged on the right lower portion of the main display 2010B. Also a bet number display portion which displays the bet number may also be provided. The payout number provided to the player may be displayed on the payout number display portion 2019. And the credit number which is presently owned by the player is displayed on the credit number display portion 2020.

The upper display 2010A and the main display 2010B, for example, are constructed from the liquid crystal panel as described above, however, this invention is not limited to the liquid crystal panel. In other words, either display portion may also be the CRT display, the plasma display, the LED display, and the other well-known display device.

The lower back panel 2010C is arranged on the lower column of the cabinet 2002, and is constructed from a plastic panel. The drawings of the characters relating to the gaming machine, the name of the gaming machine and the like are displayed on the lower back panel 2010C, and are lighted by the back lights. The lower back panel 2010C may also be the liquid crystal panel, the CRT display, the plasma display, the LED display, and the other well-known display device.

Further, the main display 2010B may also be configured as a hybrid type which is constructed from a mechanical reel and a transparent liquid crystal display device arranged in front of the mechanical reel. As a result, the symbols displayed on the mechanical reel may be visible via the transparent liquid crystal display device. Display windows which equals to the number of the mechanical reel are arranged on the transparent liquid crystal display device, so that the symbols displayed on the mechanical reel may be visible via the display windows. The slot machine using video reels will be mainly described in the below description, however, the invention may also be applied to the slot machines using the mechanical reels as much as possible. When mechanical reels are used, the rotation or the stop of the mechanical reels is controlled by a motor which is not shown.

Also, an operation table 2025 is arranged in front of the cabinet 2002. The operation table 2025 is arranged to extend forward between the main display 2010B and the lower back panel 2010C. Plural types of operation button 2026 are provided on the operation table 2025. The operation buttons 2026 include a BET button, a collect button, a start button, a CASHOUT button and the like. A coin insertion slot 2027 and a bill insertion slot 2028 are arranged on the operation table 2025. The coin insertion slot 2027 receives coins which are the gaming media to the cabinet 2002. And, the bill insertion slot 2028 is used to receive the bills to the cabinet 2002.

Further, coins, bills or electronic value (credits) which are equivalent to coins or bills are used as the gaming media in the game system 2100 (including the slot machine 2001) according to the embodiment. However, the gaming media applicable in one or more aspects of the invention are not limited to coins, bills or electronic value. For example, the gaming media may also be medals, tokens, electric moneys, and tickets.

A coin tray 2029 is provided at the bottommost of the cabinet 2002. The coin tray 2029 is used to receive the coins paid out by a hopper 2064. A light emitting portion 2030 is provided around the cabinet 2002 of the slot machine 2001. The light emitting portion 2030 is lighted up in a predetermined lighting mode when the player wins the game or during the event game. Further, a speaker 2031 is provided on the side surface of the cabinet 2002. The speaker 2031 outputs sound in accordance with the progressing of the game.

The topper effect device 2004 has a rectangular board shape, and is arranged almost parallel to the upper display 2010A.

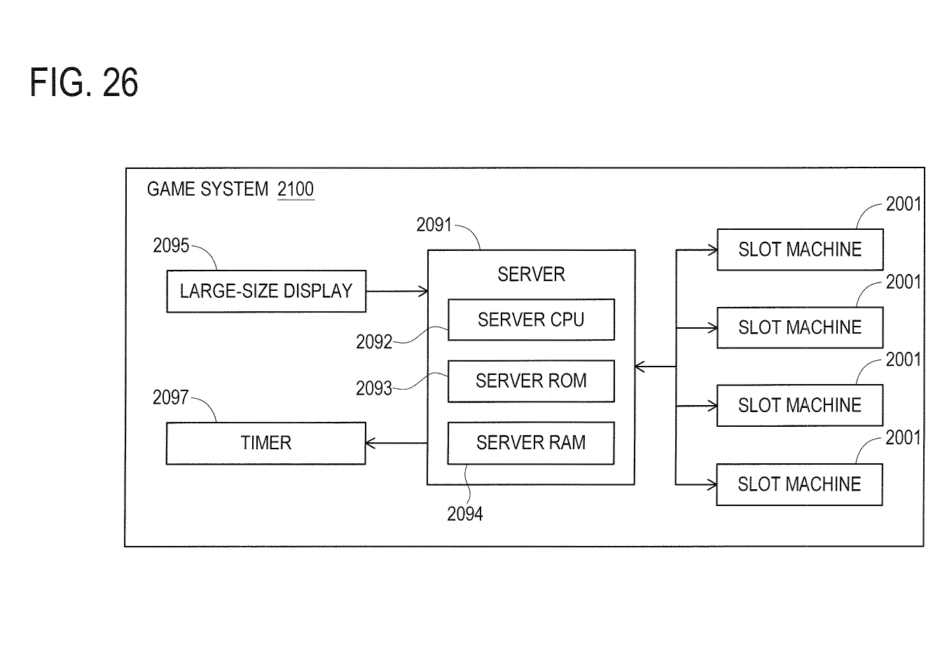

Next, the internal constitution of the game system 2100 according to the embodiment will be explained in detail with reference to the drawing. FIG. 26 is a block diagram schematically showing the internal constitution of the game system 2100.

As shown in FIG. 26, the game system 2100 includes the server 2091. The server 2091 controls the entirety of the game system 2100.

The server 2091 is constructed from a server CPU 2092, a server ROM 2093, and a server RAM 2094. The server ROM 2093 stores necessary control programs for controlling the entirety of the game system 2100 and the data tables. For example, programs for a server base process, or the like to be described later are stored. The server CPU 2092 executes the various control programs stored in the server ROM 2093. Also, a lottery table for the mystery bonus to be described later is stored in the server ROM 2093.

The server RAM 2094 temporarily stores the calculation results and the like when the various control programs are executed by the server CPU 2092. A table for a number of games and a table for a difference value are stored in the server RAM 2094. Also, the total number of games and the trigger number to be described later are stored in the server RAM 2094.

Plural slot machines 2001 are connected to the sever 2091. The server 2091 sends and receives various data with the plural slot machines 2001.

The large-size display 2095 is connected to the server 2091. The display content of the large-size display 2095 is controlled by the server 2091. When the server 2091 sends the display instruction information, a screen corresponding to the received display instruction information is displayed.

A timer 2097 is connected to the sever 2091. The server 2091 obtains the current time data by referring to the timer 2097.

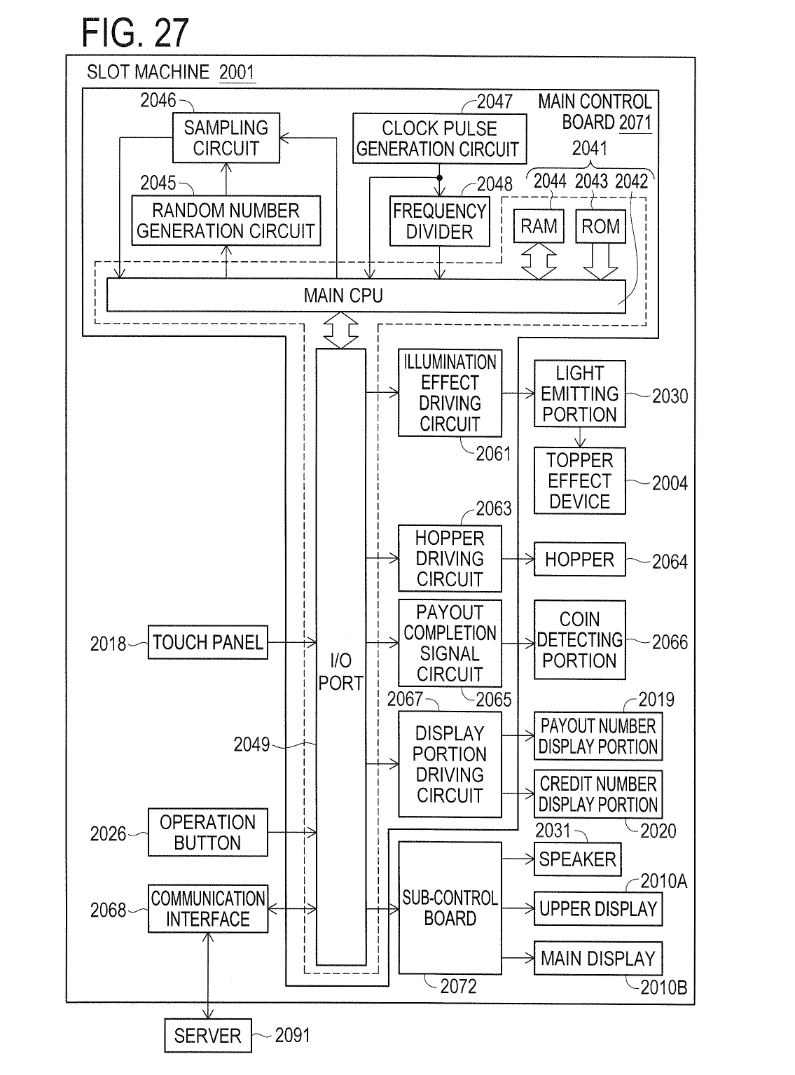

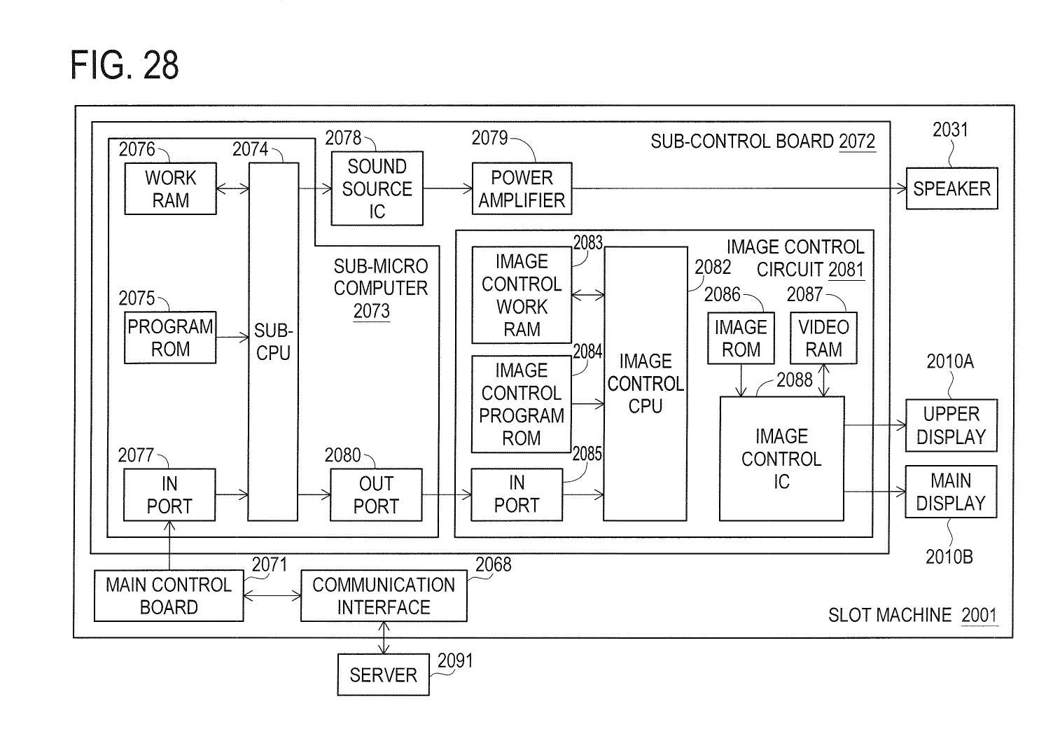

Next, the internal constitution of the slot machine 2001 according to the embodiment will be explained in detail with reference to the drawings. FIG. 27 and FIG. 28 are block diagrams showing the internal constitution of the slot machine 2001.

As shown in FIG. 27, the slot machine 2001 includes plural constitution elements around the main control board 2071.

A controller 2041 includes a main CPU 2042, a ROM 2043, a RAM 2044. The main CPU 2042 inputs or outputs signals with other constitution elements via I/O port 2049, and executes the programs stored in the ROM 2043. The main CPU 2042 serves as a control center of the slot machine 2001. The RAM 2044 stores temporarily the data and the programs when the main CPU 2042 runs. For example, the RAM 2044 temporarily stores the random number value sampled by a sampling circuit 2046 to be described later. And the identification number of the slot machine 2001 is stored in the ROM 2043 or the RAM 2044. The ROM 2043 stores the programs executed by the main CPU 2042 and the permanent data.

The main control board 2071 includes a random number generation circuit 2045, a sampling circuit 2046, a clock pulse generation circuit 2047 and a frequency divider 2048.

The random number generation circuit 2045 operates based on the instruction of the main CPU 2042, and generates a predetermined range of random numbers. The sampling circuit 2046 extracts an arbitrary random number from the random numbers generated by the random number generation circuit 2045 based on the instruction of the main CPU 2042. The sampling circuit 2046 input the extracted random number to the main CPU 2042. The clock pulse generation circuit 2047 generates a basic clock to run the main CPU 2042. The frequency divider 2048 divides the basic clock in a predetermined frequency, and inputs the divided signals to the main CPU 2042.

The touch panel 2018 is connected to the main control board 2071. The touch panel 2018 may specify the coordinate position of the part to which the player touches. The touch panel 2018 may determine the portion to which the player touches based on the specified coordinate position information, and determines the direction to which the touched place moves. The touch panel 2018 inputs the signal corresponding to the determination result via the I/O port 2049 to the main CPU 2042.

The operation button 2026 is connected to the main control board 2071. As described above, the operation button 2026 includes the start button, the collect button, the BET button and the like to instruct the execution of the game. When each button included in the operation buttons 2026 is pressed, the operation signal is input to the main CPU 2042 via the I/O port 2049.

A communication interface 2068 is connected to the main control board 2071. The communication interface 2068 is used to receive or send various data with the sever 91.

The main control board 2071 also includes an illumination effect driving circuit 2061, a hopper driving circuit 2063, a payout completion signal circuit 2065 and a display portion driving circuit 2067.

The illumination effect driving circuit 2061 outputs effect signals to the above-mentioned light emitting portion 2030 and the topper effect device 2004. And the topper effect device 2004 is serially connected to the illumination effect driving circuit 2061 through light emitting portions 2030. When the effect signal is input, the light emitting portions 2030 and the topper effect device 2004 emit light in a predetermined light emitting mode. As a result, the slot machine 2001 executes light emitting effect in accordance with the progressing of the game.

The hopper driving circuit 2063 drives the hopper 2064 based on the control of the main CPU 2042. The hopper 2064 executes the payout of coins, and thereby, coins are paid out to the coin tray 2029. The display portion driving circuit 2067 executes the display control of various display portions such as the payout number display portion 2019, the credit number display portion 2020 and the like.

A coin detecting portion 2066 is connected to the payout completion signal circuit 2065. The coin detecting portion 2066 calculates the number of the coins paid out by the hopper 2064. The coin detecting portion 2066 inputs the data of the number of coins which is calculated to the payout completion signal circuit 2065. The payout completion signal circuit 2065 determines whether the predetermined number of coins is paid out or not based on the data of the number of coins input by the coin detecting portion 2066. When the coins with a predetermined number are all paid out, the signal indicating the completion of the coins is input to the main CPU 2042 by the payout completion signal circuit 2065.

A sub-control board 2072 is connected to the main control board 2071. The sub-control board 2072 is formed on a circuit board different from that of the main control board 2071. The display control of the upper display 2010A, the main display 2010B and the output control of sound by the speaker 2031 are executed by the sub-control board 2072, based on the commands input from the main control board 2071.

As shown in FIG. 28, the sub-control board 2072 includes a microcomputer 2073 (abbreviated as “sub-microcomputer” hereinafter) as a main constitution element. The sub-microcomputer 2073 includes a sub-CPU 2074, a program ROM 2075, a work RAM 2076, an IN port 2077 and an OUT port 2080. The sub-CPU 2074 executes the control operations based on the control orders (commands) sent from the main control board 2071. The program ROM 2075 stores the control programs executed by the sub-CPU 2074. The work RAM 2076 is configured as a temporary storing device when the above control programs are executed by the sub-CPU 2074.

The sub-control board 2072 executes the random number sampling on the running program of the sub-CPU 2074. As a result, the sub-control board 2072 may execute the same processes as the processes executed by the clock pulse generation circuit 2047, the frequency divider 2048, the random number generation circuit 2045, and the sampling circuit 2046 in the main control board 2071.

The sub-control board 2072 includes a sound source IC 2078, a power amplifier 2079 and an image control circuit 2081. The sound source IC 2078 controls the sound output from the speaker 2031. The power amplifier 2079 is used as an amplifier for the output of the sound. And the image control circuit 2081 is running as the display control device of the upper display 2010A and the main display 2010B.

The image control circuit 2081 includes an image control CPU 2082, an image control work RAM 2083, an image control program ROM 2084, an image ROM 2086, a video RAM 2087 and an image control IC 2088. The image control CPU 2082 determines the images displayed on the upper display 2010A and the main display 2010B based on the parameters set by the sub-microcomputer 2073 and the image control programs.

The image control programs regarding to the display of the upper display 2010A and the main display 2010B and a variety of the selection tables are stored in the image control program ROM 2084. The image control work RAM 2083 serves as a temporary storing device when the image control programs are executed by the image control CPU 2082. IN port 2085 is connected to the OUT port 2080. Images corresponding to the content determined by the image control CPU 2082 are formed by the image control IC 2088, and are output to the upper display 2010A and the main display 2010B. The dot data used to form images are stored in the image ROM 2086. The video RAM 2087 serves as a temporary storing device when the images are formed by the image control IC 2088.

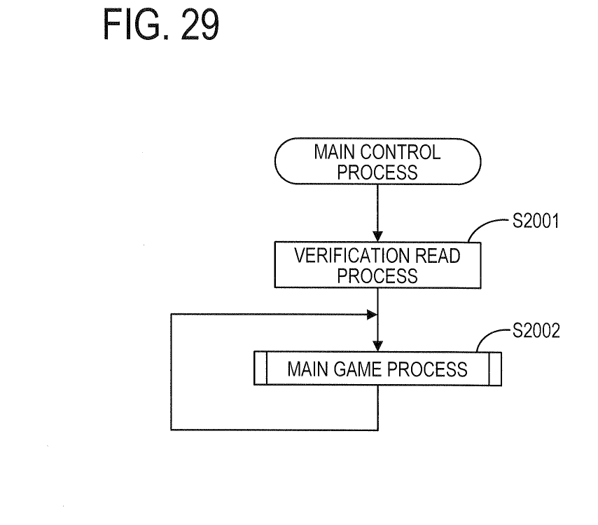

Next, the main control process executed in slot machine 2001 according to the embodiment will be explained with reference to the drawing. FIG. 29 is a flowchart of the main control process. The programs for executing the main control process are stored in the ROM 2043 of the slot machine 2001, and are executed by the main CPU 2042.

When the power switch is ON (the power is turned ON), the main control board 2071 and the sub-control board 2072 are activated respectively, the controller 2041 executes the verification read process of S2001. In the verification read process S2001, the main CPU 2042 executes the BIOS stored in the ROM 2043, and extracts the compressed data incorporated in the BIOS to the RAM 2044. And once the BIOS extracted in the RAM 2044 is executed, diagnosis of the variety of peripheral devices and initialization are executed by the main CPU 2042. Further, the CPU 2042 writes the game programs from the ROM 2043 to the RAM 2044. And also the CPU 2042 executes the certification process to each program during the execution of the initial setting process.

In S2002, the game program and the like are read out from the RAM 2044 in sequence and are executed so as to progress the main game process. The game in the slot machine 2001 according to the embodiment is progressed by the execution of the main game process. And, the main game process is repeated to be executed during the power of the slot machine 2001 is supplied.

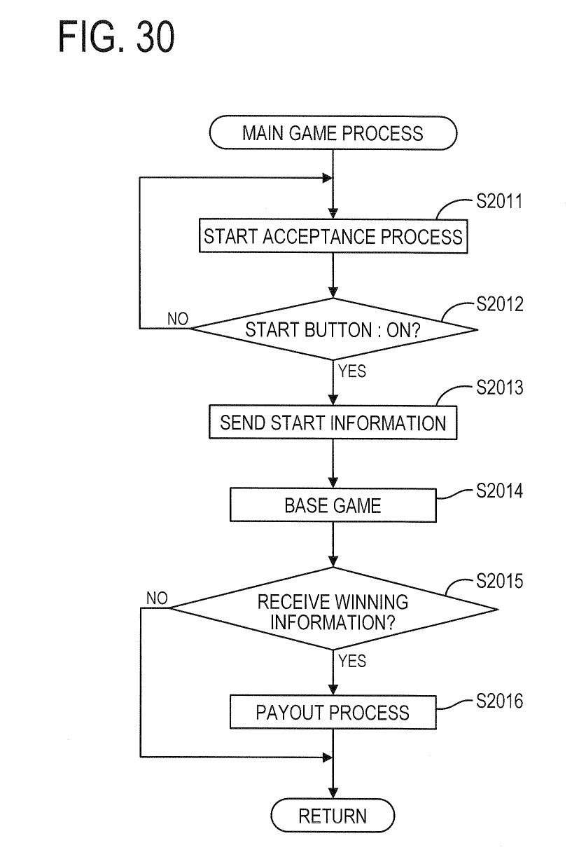

Next, the main game process will be described in detail with reference to the drawing. FIG. 30 is a flowchart of the main game process.

In S2011, the start acceptance process is executed. In the start acceptance process, after the predetermined initial setting is executed, the setting of the bet number and the like are executed. And, the input of coins is executed by the player from the coin insertion slot 2027. The bet operation using the operation button 2026 is also executed. The number of the coins inserted from the coin insertion slot 2027 or the bet operation using the operation button 2026 is detected respectively.

In S2012, it is determined whether or not the start button is operated. The determination whether the start button is operated is executed based on whether or not the input signal is received from the start switch.

If it is determined that the start button is not operated (S2012: NO), the game returns to the start acceptance process. The operation such as correction of the bet number is possible at this time. On the other hand, if it is determined that the start button is operated (S2012: YES), the bet number which is set is deducted from the credits owned by the player, and the subtraction result is stored in the RAM 2044 as the betting information. And then, the game proceeds to S2013.

In S2013, start information is sent to the server 2091. The start information includes a bet amount and the identification number (ID) of slot machine 2001.

In S2014, a base game is progressed. In the base game, for example, the symbol rows are variably displayed on the symbol display portion, and then the symbol rows are stopped and displayed. Awards are provided based on the symbol combination of the symbols stopped and displayed. As the base game, various well-known games may be executed. And, a predetermined award may be provided based on the game result. And then the game proceeds to S2015.

In S2015, it is determined whether or not the winning information is received from the server 2091. If it is determined that the winning information is not received from the server 2091 (S2015: NO), the main game process is terminated. On the other hand, if it is determined that the winning information is received from the server 2091 (S2015: YES), the game proceeds to S2016. The mystery bonus is realized by receiving the winning information.

In S2016, a payout process is executed. In the payout process, gaming medium may be paid out based on a payout amount included in the winning information.

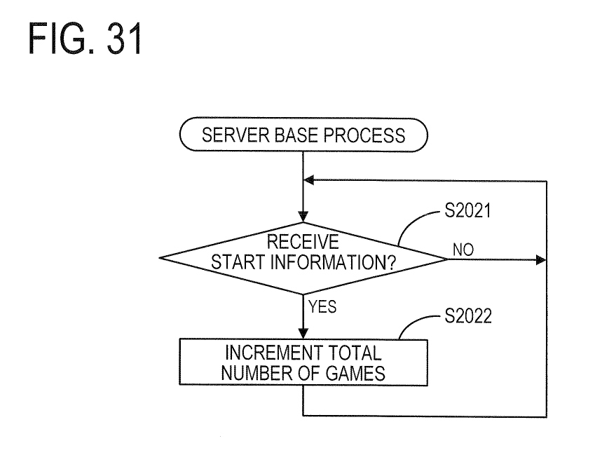

Next, a server base process executed in the server 2091 will be described. FIG. 31 is a flowchart of the server base process. Programs for executing the server base process are stored in the server ROM 2093 of the server 2091, and are executed by the server CPU 2092.

In S2021, it is determined whether or not the start information is received. If the start information is not received from any gaming machine (S2021: NO), the game returns to S2021. On the other hand, if the start information is received from any gaming machine (S2021: YES), the game shifts to S2022. In S2022, the total number of the games stored in the server RAM 2094 is incremented.

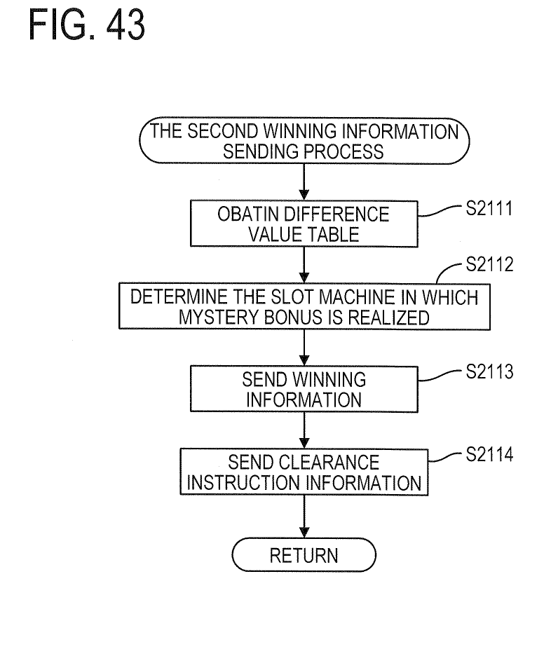

Next, a server lottery process executed in the server 2091 will be described. FIG. 43 is a flowchart of the server lottery process. Programs for executing the server lottery process are stored in the server ROM 2093 of the server 2091, and are executed by the server CPU 2092. And, the lottery of the mystery bonus is executed in a predetermined time period (for example, every 10 seconds). Also, the sever lottery process may be executed parallel to the above server base process.

In S2031, a lottery for the mystery bonus is conducted. That is, it is determined whether or not the mystery bonus is won by lottery.

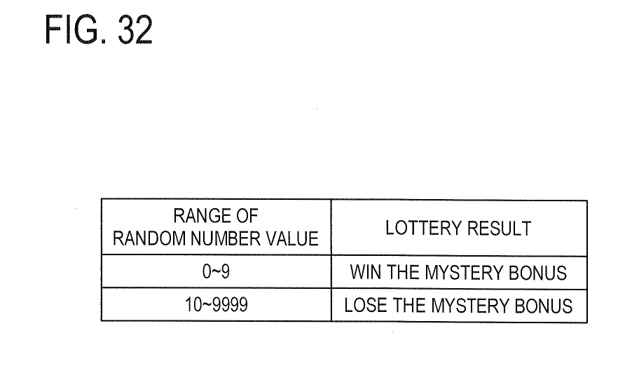

Hereinafter, a lottery method for the mystery bonus will be described. FIG. 32 is one example of a lottery table of the mystery bonus. The lottery table is stored in the server ROM 2093, and it is write in the server RAM 2094 and used. A range for the random number value is 0 through 9999, and when any random number value in the range of 0 through 9 is selected, the mystery bonus is won. Further, the range for the random number value and/or the correspondence relationship between the random number value and a result of lottery may be set appropriately.

In S2032, it is determined whether or not the mystery bonus is won. If it is determined that the mystery bonus is not won (S2032: NO), the game returns to S2031. On the other hand, if it is determined that the mystery bonus is won (S2032: YES), the game proceeds to S2033.

In S2033, the trigger number is determined by lottery. For example, the trigger number may be determined from a range of 1000 to 2000. The determined trigger number is stored in the server RAM 2094. And, the range of the trigger number may be set appropriately.

In S2034, display content to be displayed on the large-size display 2095 is determined. For example, in S2033, when the trigger number is determined as 500, the display content is determined as “Bonus Announcement!! A mystery bonus will occur at any slot machine before the total number of games becomes 1000”. That is, the number of games included in the display content is a number later than the trigger number.

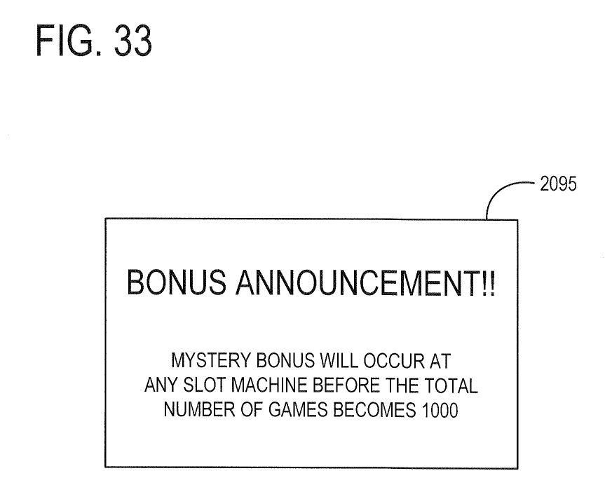

Then, display instruction information including the determined display content will be sent to the large-size display 2095. FIG. 33 is one example of display content displayed on the large-size display 2095.

In S2035, a total number of games from the winning of the mystery bonus is obtained. Here, the server RAM 2094 is referred. When the mystery bonus is won, since the total number of games at that time is stored in the server RAM 2094 (hereinafter, abbreviated as “total number of games at winning”), the difference value between the “total number of games at winning” and the current total number of games will be calculated as “a total number of games from the winning of the mystery bonus” (hereinafter, abbreviated as “second total number of games”).

In S2036, it is determined whether or not the second total number of games becomes the trigger number. If it is determined that the total number of games has not become the trigger number (S2036: NO), the game returns to S2035. On the other hand, if it is determined that the second total number of games becomes the trigger number (S2036: YES), the game shifts to S2037.

When the process is in S2035 or in S2036, the mystery bonus is won inside the server 2091, however, the mystery bonus is not yet realized in any of the slot machines 2001 (namely, the server 2091 is in a stock state).

In S2037, it is determined whether or not start information is received from any of the slot machines 2001. If it is determined that the start information is not received from any of the slot machines 2001 (S2037: NO), the game returns to S2037. In other words, the process will wait in S2037 until the start information is received from any of the slot machines 2001.

On the other hand, if it is determined that the start information is received from any of the slot machines 2001 (S2037: YES), the game proceeds to S2038.

In S2038, the winning information is sent to the slot machine which has sent the start information first. That is, the mystery bonus is realized in the slot machine which has sent the start information first. The winning information includes information indicating that the mystery bonus is realized and information indicating payout amount. The payout amount may be set appropriately. When the winning information is sent, the game returns to S2031.

According to the fourth embodiment described above, when the mystery bonus is won inside the server 2091, the trigger number for the mystery bonus is determined by the server 2091, the display content is determined based the determined trigger number, and the display content is displayed on the large-size display 2095. When the total number of games from the winning of the mystery bonus becomes the trigger number, the mystery bonus is provided to the slot machine 2001 in which the start operation is first conducted since then.

Herewith, the entertainment aspect will be enhanced and one or more aspects of the invention can attract more players. Also, a playing time of each of the slot machines 2001 may be enhanced. Also, since the occurrence of the mystery bonus is announced on the large-size display 2095, vacant slot machines 2001 can attract the players. Accordingly, a working ratio of the slot machines 2001 may be increased. That is, a playing time of the slot machine 2001 may be enhanced.

### Fifth Embodiment

Next, a fifth embodiment embodying one or more aspects of the invention will be described with reference to the drawings. Since the main control program and the main game program are the same as those in the fourth embodiment, description will be omitted here.

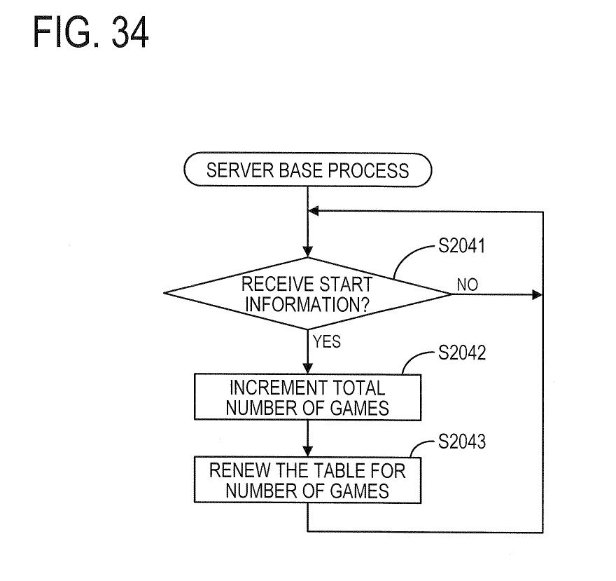

The server base process in the fifth embodiment will be described with reference to the drawing. FIG. 34 is a flowchart of the server base process.

In S2041, it is determined whether the start information is received from any of the slot machines 2001. If it is determined that the start information is not received from any of the slot machines 2001 (S2041: NO), the game returns to S2041.

On the other hand, if it is determined that the start information is received from any of the slot machines 2001 (S2041: YES), the game proceeds to S2042. In S2042, the total number of games stored in the server RAM 2094 is incremented.

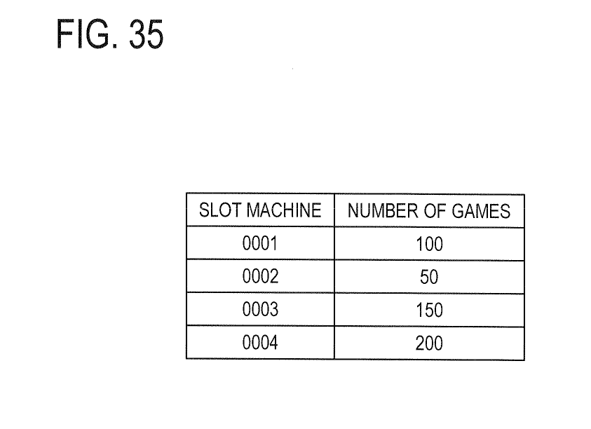

In S2043, a table for number of games is renewed. The number of games is stored in the server RAM 2094. FIG. 35 shows one example of a table for number of games. FIG. 35 shows that a slot machine having ID “0001”, a slot machine having ID “0002”, a slot machine having ID “0003”, and a slot machine having ID “0004” are connected to the server 2091.

The number of games in each of slot machines is 100 times, 50 times, 150 times, and 200 times respectively from the time when the last mystery bonus is realized.

In the state shown in FIG. 35, for example, when the start information is received from the slot machine having ID “0002”, the number of games corresponding to the slot machine 2001 having ID “0002” is renewed from “50” to “51”.

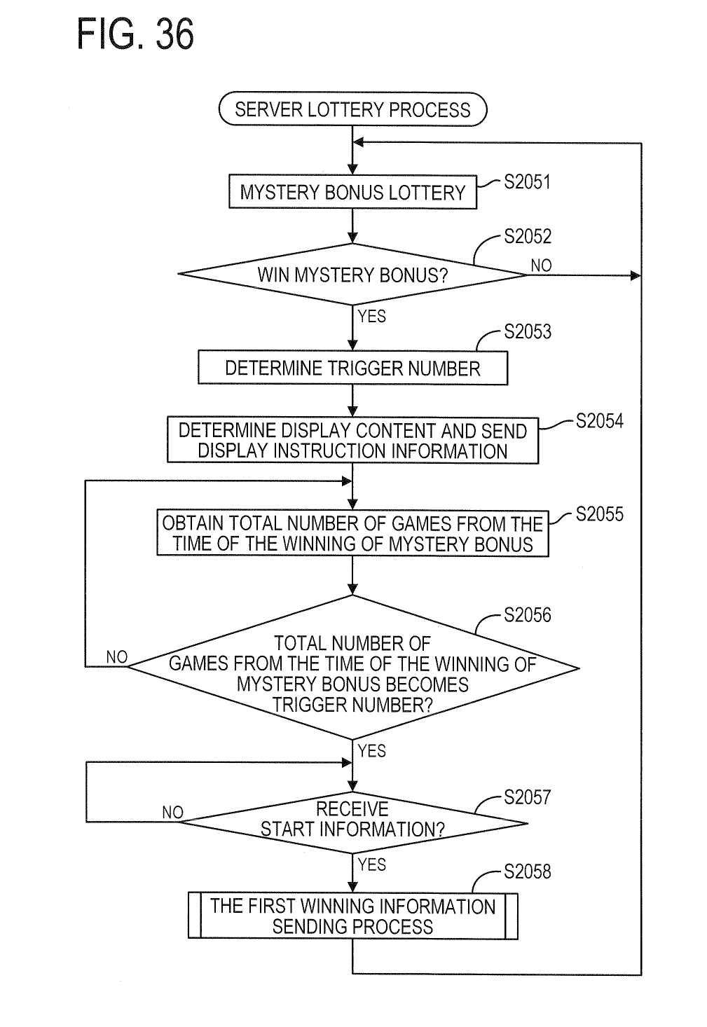

Next, the server lottery process executed in the server 2091 will be described. FIG. 36 is a flowchart of the server lottery process. Programs to implement the server lottery process are stored in the server ROM 2093 of the server 2091, and are executed by the server CPU 2092. The mystery bonus lottery is conducted in a predetermined time period (for example, every 10 seconds). Further, the server lottery process may be executed parallel to the above server base process.

Since the processes of S2051 through S2057 are the same as the processes of S2031 to S2037 in the fourth embodiment (see FIG. 43), description will be omitted.

When the process is in S2055 or in S2056, the mystery bonus is won inside the server 2091, however, the mystery bonus is not yet realized in any of the slot machines 2001 (namely, the server 2091 is in a stock state).

In S2058, the first winning information sending process is executed.

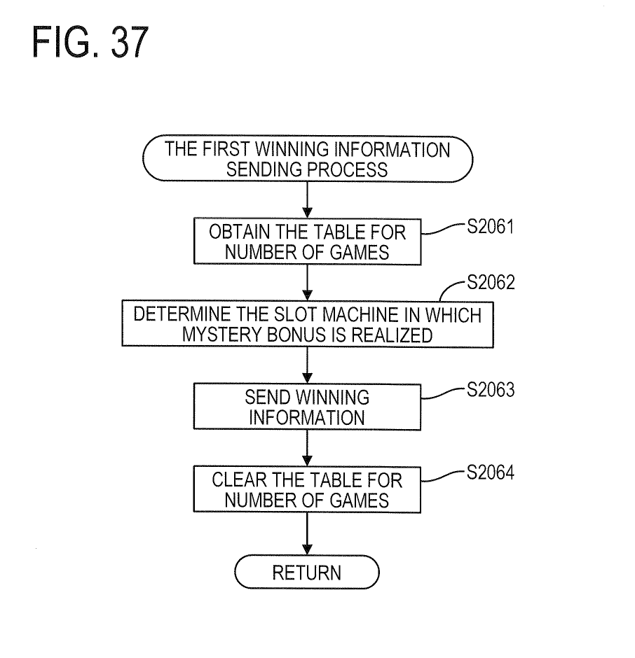

Hereinafter, the first winning information sending process will be described. FIG. 37 is a flowchart of the first winning information sending process.

In S2061, the table for the number of games is obtained. Here, the server RAM 2094 is referred.

In S2062, a slot machine in which the mystery bonus is realized is determined. The determination method of the slot machine in which the mystery bonus is realized will be described.

First, winning probability of each slot machine 2001 will be determined based on contents of the table for the number of games.

For example, in a state shown in FIG. 35, ratio of the number of games in each slot machine of the slot machine having ID “0001”, the slot machine having ID “0002”, the slot machine having ID “0003”, and the slot machine having ID “0004”, is [2:1:3:4]. Also, the winning probability is determined in accordance with the ratio of the number of games.

As a result, the winning probability of the slot machine having ID “0001” may be defined as 20%.

The winning probability of the slot machine having ID “0002” may be defined as 10%.

The winning probability of the slot machine having ID “0003” may be defined as 30%.

The winning probability of the slot machine having ID “0004” may be defined as 40%.

Here, the slot machine with a larger number of games has a higher winning probability. In other words, as the number of games is larger, as the winning probability is higher.

The corresponding relationship between the number of games and the winning probability may be determined appropriately.

After that, the slot machine in which the mystery bonus is realized will be determined based on the determined winning probability.

In S2063, the winning information is sent to the slot machine in which the mystery bonus is realized. In other words, the mystery bonus is realized in the slot machine which received the start information. The winning information includes information indicating that the mystery bonus is realized and information indicating a payout amount.

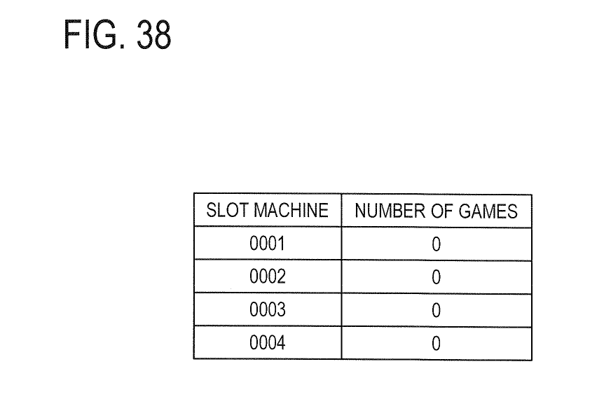

In S2064, the number of games of each slot machine 2001 in the table for the number of games is cleared. FIG. 38 shows contents of the table for the number of games which has been cleared.

According to the fifth embodiment described above, when the mystery bonus is won inside the server 2091, the trigger number for the mystery bonus is determined by the server 2091, the display content is determined based on information of the determined trigger number, and the display content is displayed on the large-size display 2095. When the total number of games becomes the trigger number, the slot machine in which the mystery bonus is realized will be determined by lottery. Here, the slot machine in which the mystery bonus is realized will be determined based on the number of games in each slot machine from the time when the last mystery bonus is realized. Also, the slot machine in which the mystery bonus is realized may be determined based on the number of games in each slot machine from the time when the current mystery bonus is realized.

Herewith, the entertainment aspect will be enhanced and one or more aspects of the invention can attract more players. Also, since as the number of games is larger, as the winning probability of the mystery bonus is higher, the player tends to play more games. Accordingly, a playing time of each of the slot machines 2001 may be enhanced.

Also, since the occurrence of the mystery bonus is announced on the large-size display 2095, vacant slot machines 2001 can attract the players. Accordingly, a working ratio of the slot machines 2001 may be increased. That is, a playing time of the slot machine 2001 may be enhanced.

### Sixth Embodiment

Next, a sixth embodiment embodying one or more aspects of the invention will be described with reference to the drawings. Since the main control program executed in slot machine 2001 is the same as that in the fourth embodiment, description will be omitted here.

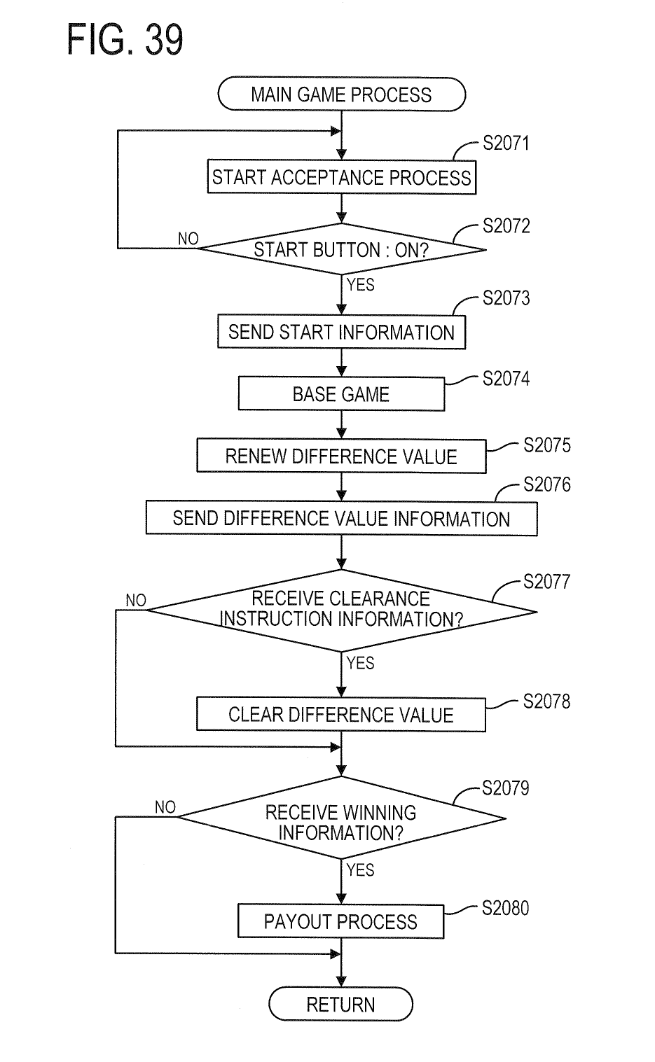

Next, the main game process in the sixth embodiment will be described with reference to the drawing. FIG. 39 is a flowchart of the main game process.

Since the processes of S2071 to S2074 are the same as the processes of S2011 to S2014 in the fourth embodiment (see FIG. 30), description will be omitted.

In S2075, the difference value is renewed. The difference value is increased by the bet amount set in the bet operation of S2071, and is decreased by the payout amount of the gaming medium. In other words, when the payout amount to the player is smaller, the difference value becomes larger. When the payout amount to the player is larger, the difference value becomes smaller. That is, as the smaller the payout amount is, the larger the difference value is. Also, as the payout amount is larger, as the difference value is smaller.

Also, the renewal of the difference value may be executed when the start button is turned ON, and when the gaming media are paid out in the base game.

In S2076, difference value information is sent to the server 2091. The difference value information includes the ID and the difference value of the slot machine 2001. The timing to send the difference value information to the server 2091 may be set at a different timing.

In S2077, it is determined whether or not clearance instruction information is received from the server 2091. If it is determined that the clearance instruction information is not received from the server 2091 (S2077: NO), the game proceeds to S2079. On the other hand, if it is determined that the clearance instruction information is received from the server 2091 (S2077: YES), the game proceeds to S2078. When the mystery bonus is realized in any of the slot machines 2001, the clearance instruction information is received.

In S2078, the difference value stored in the server RAM 2094 is cleared.

In S2079, it is determined whether or not the winning information is received from the server 2091. If it is determined that the winning information is not received from the server 2091 (S2079: NO), the main game process is terminated. On the other hand, if it is determined that the winning information is received from the server 2091 (S2079: YES), the game proceeds to S2080.

In S2080, the payout process is executed. In the payout process, gaming media are paid out based on payout amount included in the winning information.

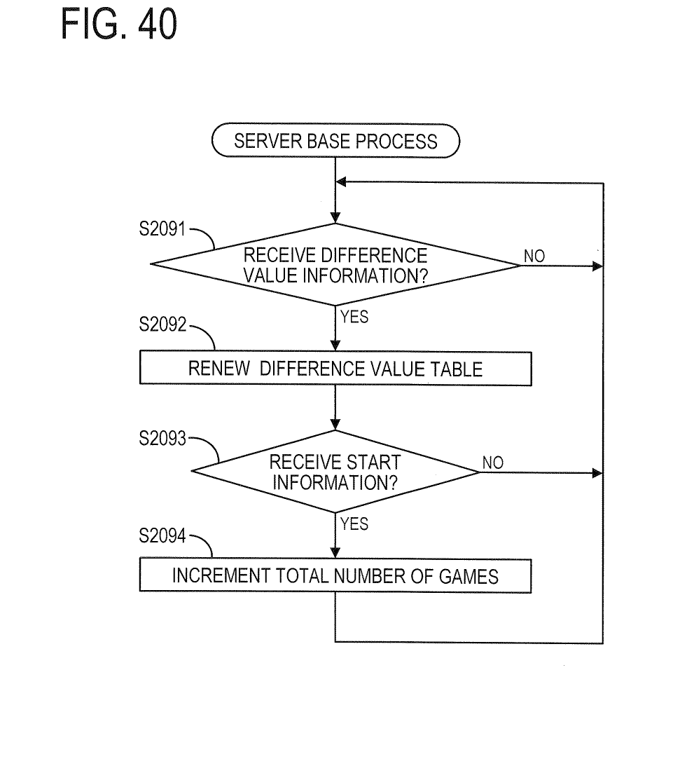

Next, the server base process in the sixth embodiment will be described with reference to the drawing. FIG. 40 is a flowchart of the server base process.

In S2091, it is determined whether or not the difference value information is received from any slot machine 2001. If it is determined that the difference value information is not received from any slot machine 2001 (S2091: NO), the game returns to S2091.

On the other hand, if it is determined that the winning information is received from the server 2091 (S2091: YES), the game proceeds to S2092.

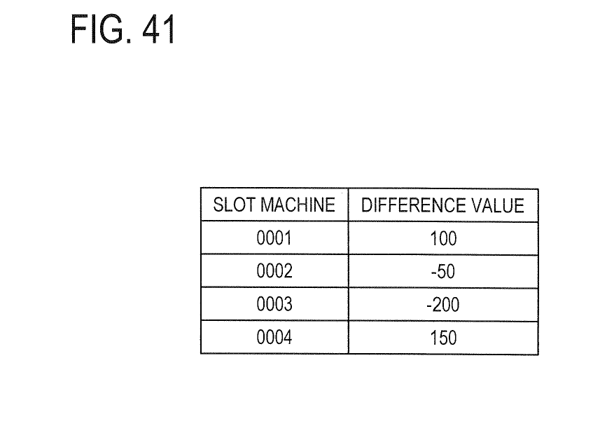

In S2092, a difference value table is renewed. The difference value table is stored in the server RAM 2094. FIG. 41 shows one example of a difference value table. FIG. 40 shows that the slot machine having ID “0001”, the slot machine having ID “0002”, the slot machine having ID “0003”, and the slot machine having ID “0004” are connected to the server 2091.

The difference value in each slot machine from the time when the last mystery bonus is realized is “100 denominations”, “−50 denominations”, “−200 denominations”, “150 denominations”. Also, 1 denomination may be set appropriately. For example, 1 denomination may be defined as 1$, or 1 denomination may be defined as 25¢.

In a state shown in FIG. 40, for example, when the difference value information including the difference value of “10” is received from the slot machine having ID “0002”, the difference value corresponding to the slot machine having ID “0002” is renewed from “−50” to “−40”.

Now the description will be returned to FIG. 40. In S2093, it is determined whether or not the start information is received. If the start information is not received from any gaming machine (S2093: NO), the game returns to S2091. On the other hand, if the start information is received from any gaming machine (S2093: YES), the game shifts to S2094. In S2094, the total number of the games stored in the server RAM 2094 will be incremented. And then, the game returns to S2091.

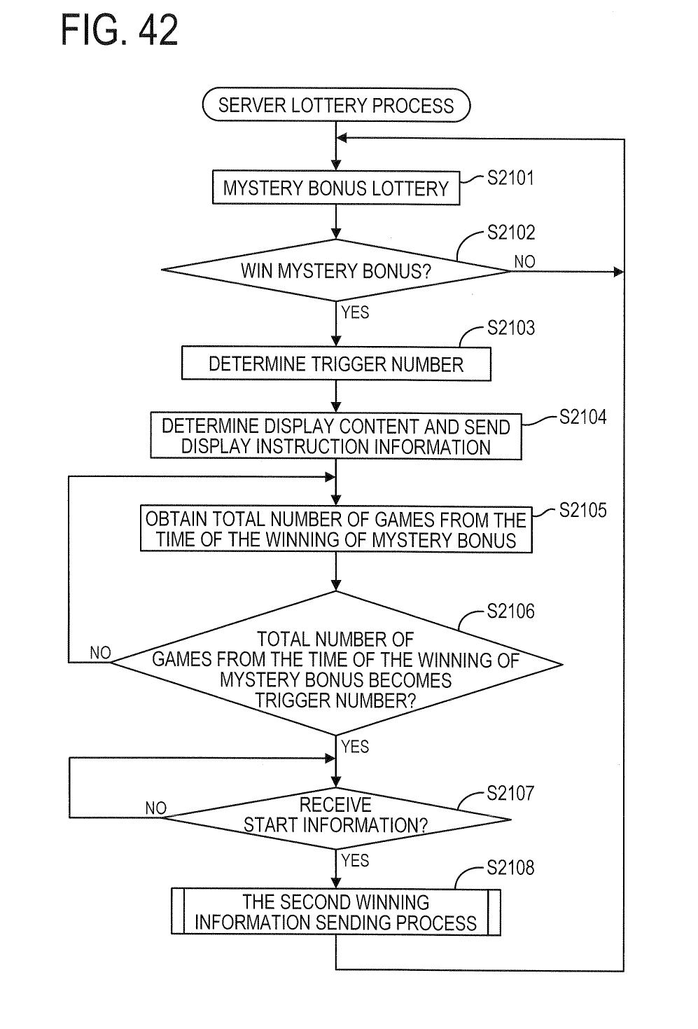

Next, the server lottery process executed in the server 2091 will be described. FIG. 42 is a flowchart of the server lottery process. Programs to implement the server lottery process are stored in the server ROM 2093 of the server 2091, and are executed by the server CPU 2092. The mystery bonus lottery is conducted in a predetermined time period (for example, every 10 seconds). Further, the server lottery process may be executed parallel to the above server base process.

Since the processes of S2101 to S2107 are the same as the processes of S2031 to S2037 in the fourth embodiment (see FIG. 43), description will be omitted.

During the process between S2105 or S2106, the mystery bonus is won inside the server 2091, however, the mystery bonus is not yet realized in any of the slot machines 2001 (namely, the server 2091 is in a stock state).

In S2108, the second winning information sending process is executed.

Hereinafter, the second winning information sending process will be described. FIG. 43 is a flowchart of the second winning information sending process.

In S2111, the table of the difference value is obtained. Here, the server RAM 2094 is referred.

In S2112, a slot machine in which the mystery bonus is realized is determined. The determination method of the slot machine in which the mystery bonus is realized will be described.

First, winning probability of each slot machine 2001 will be determined based on contents of the table of the difference value.

For example, in the state shown in FIG. 41, the winning probability of the slot machine having ID “0001” may be defined as 30%.

The winning probability of the slot machine having ID “0002” may be defined as 20%.

The winning probability of the slot machine having ID “0003” may be defined as 10%.

The winning probability of the slot machine having ID “0004” may be defined as 40%.

That is, the slot machine with a larger difference value has a higher winning probability. In other words, the slot machine having a less payout amount to the player, the winning probability is higher.

Namely, the larger the difference value is, the higher the winning probability is. Also, the smaller the payout amount is, the higher the winning probability is.

The corresponding relationship between the number of games and the winning probability may be determined appropriately.

After that, the slot machine in which the mystery bonus is realized is determined based on the determined winning probability.

In S2113, the winning information is sent to the slot machine in which the mystery bonus is realized. In other words, the mystery bonus is realized in the slot machine which received the start information. The winning information includes information indicating that the mystery bonus is realized and information indicating a payout amount.

In S2114, the clearance instruction information will be sent to each slot machine 2001.

According to the sixth embodiment described above, when the mystery bonus is won inside the server 2091, the trigger number for the mystery bonus is determined by the server 2091, the display content is determined based on information of the determined occurrence time, and the display content is displayed on the large-size display 2095. When the total number of games becomes the trigger number, the slot machine in which the mystery bonus will be realized is determined by lottery. Here, the slot machine in which the mystery bonus will be realized is determined based on the difference value between the bet amount and the payout amount of each slot machine from the time when the last mystery bonus is realized. Also, the slot machine in which the mystery bonus is realized may be determined based on the difference value between the bet amount and the payout amount of each slot machine from the winning time of the current mystery bonus.

Herewith, the entertainment aspect will be enhanced and one or more aspects of the invention can attract more players. Also, since the payout amount is smaller as the winning probability of the mystery bonus is higher, the player who put in more credits may anticipate the mystery bonus more.

Also, since the occurrence of the mystery bonus is announced on the large-size display 2095, vacant slot machines 2001 can attract the players. Accordingly, a working ratio of the slot machines 2001 may be increased. That is, a playing time of the slot machine 2001 may be enhanced.

Here, aspects of the invention are not limited to the above embodiment and various changes and modification can be done within the scope of the present invention.

For example, one or more aspects of the invention may also be applied to the game system with link progressive bonus. In this case, the invention may be configured to accumulatively adding up a part of the bet number in each slot machine, and the accumulatively added number may be paid out to the slot machine which wins the bonus.

When a predetermined condition is satisfied during the main game process, the free game may be executed.

One or more aspects of the invention may be applied as a gaming method to execute the above process. Further, one or more aspects of the invention may be applied to the program for executing the gaming method by computer, or may be applied as the record medium (tangible medium) in which the program is stored.

What is claimed is:

1. A game system comprising:
gaming machines:
a server connected to the gaming machines; and
a display;
wherein
the server is programmed to:
(a) determine a second predetermined time at a first predetermined time,
(b) determine display content based the determined second predetermined time,
(c) display the determined display content on the display,
(d) determine a specific gaming machine of the gaming machines when a current time becomes the second predetermined time, the specific gaming machine realizing a bonus, and
(e) send winning information to the determined specific gaming machine, each of the gaming machine is programmed to:
(A) send predetermined information to the server when a start operation of a game is accepted, and
(B) provide a predetermined number of gaming medium when the winning information is received.

2. The game system according to claim 1, wherein the bonus is won inside the server at the first predetermined time.

3. The game system according to claim 1, wherein the specific gaming machine provided with the bonus corresponding to a gaming machine in which an earliest start operation is made after the current time becomes the second predetermined time.

4. The game system according to claim 1, wherein the server determines the specific gaming machine based on a table, the table storing winning probabilities each corresponding to each of the gaming machine.

5. The game system according to claim 4, wherein each of the winning probabilities is determined based on a number of executed games on the corresponded the gaming machine during a time period from the first predetermined time to the second predetermined time.

6. The game system according to claim 5, wherein as the number of executed games is larger, the winning probability is higher.

7. The game system according to claim 4, wherein each of the winning probabilities is determined based on a difference value between a bet amount and a payout amount on the corresponded the gaming machine during a time period from the first predetermined time to the second predetermined time.

8. The game system according to claim 7, wherein as the difference value is larger, as the winning probability is higher.

9. A game system comprising:
gaming machines;
a server connected to the gaming machines; and
a display;
wherein
the server is programmed to:
(a) determine a trigger number at a predetermined time,
(b) clear an accumulated number at the predetermined time,
(c) determine display content based the determined trigger number,
(d) display the determined display content on the display,
(e) increment the accumulated number when a start operation of a game is made on any of the gaming machines,
(f) determine a specific gaming machine of the gaming machines when the accumulated number reaches the trigger number, the specific gaming machine realizing a bonus, and
(g) send winning information to the determined specific gaming machine, each of the gaming machine is programmed to:
(A) send predetermined information to the server when a start operation of a game is accepted, and
(B) provide a predetermined number of gaming medium when the winning information is received.

10. The game system according to claim 9, wherein the bonus is won inside the server at the predetermined time.

11. The game system according to claim 9, wherein the specific gaming machine provided with the bonus corresponding to a gaming machine in which an earliest start operation is made after the current time becomes the second predetermined time.

12. The game system according to claim 9, wherein the server determines the specific gaming machine based on a table, the table storing winning probabilities each corresponding to each of the gaming machine.

13. The game system according to claim 12, wherein each of the winning probabilities is determined based on a number of executed games on the corresponded the gaming machine during a time period from the predetermined time to a time when the accumulated number reaches the predetermined trigger number.

14. The game system according to claim 13, wherein as the number of executed games is larger, the winning probability is higher.

15. The game system according to claim 12, wherein each of the winning probabilities is determined based on a difference value between a bet amount and a payout amount on the corresponded the gaming machine during a time period from the predetermined time to a time when the accumulated number reaches the predetermined trigger number.

16. The game system according to claim 15, wherein as the difference value is larger, as the winning probability is higher.
